(19) United States
(12) Patent Application Publication
(10) Pub. No.: US 2007/0043609 A1
(43) Pub. Date: Feb. 22, 2007

(54) Automated systems for defining, implementing and tracking the sales cycle

(76) Inventors: Razi Imam, Coraopolis, PA (US); Anupam Singh, Gibsonia, PA (US); Abhijit Shome, Gibsonia, PA (US)

Correspondence Address: Daniel H. Golub, 1701 Market Street, Philadelphia, PA, 19103, US

(21) Appl. No.: 11/489,080

(22) Filed: Jul. 18, 2006

Related U.S. Application Data
(60) Provisional application No. 60/700,372, filed on Jul. 18, 2005.

(51) Int. Cl. H04M 3/51; G06F 11/34

(52) U.S. Cl. 705/11

(57) ABSTRACT

An automated system that defines, implements and tracks the sales cycle applied by salespersons within an organization to sell goods or services offered by the organization to prospective customers. A graphical user interface displays a sales workflow that includes at least a plurality of pre-defined steps of the sales cycle, and automatically tracks a completion status of each of the pre-defined steps with respect to each sales opportunity being pursued by a salesperson. The system automatically tracks the completion status displayed by the graphical user-interface by tracking actions that the sales person has taken in furtherance of the sales opportunity using the graphical user-interface.

### CROSS-REFERENCE TO RELATED APPLICATION

The present application claims priority to U.S. Patent Appl. No. 60/700,372, filed Jul. 18, 2005 for “Automated Systems For Defining, Implementing And Tracking The Sales Cycle,” incorporated herein by reference.

### BACKGROUND

One of the many business challenges faced by companies today is improving sales force effectiveness. Companies have traditionally tried to improve sales effectiveness by investing in sales training and on sales force automation (SFA) applications. Market research indicates that SFA applications have not satisfied the market need because, among other things, they lack functionality to assist the sales force in selling and closing deals. The present invention addresses these and other shortcomings in existing systems.

### SUMMARY OF THE INVENTION

The present invention is directed to an automated system that defines, implements and tracks the sales cycle applied by salespersons within an organization to sell goods or services offered by the organization to prospective customers. A graphical user interface displays a sales workflow that includes at least a plurality of pre-defined steps of the sales cycle, and automatically tracks a completion status of each of the pre-defined steps with respect to each sales opportunity being pursued by a salesperson. The system automatically tracks the completion status displayed by the graphical user-interface by tracking actions that the sales person has taken in furtherance of the sales opportunity using the graphical user-interface.

In accordance with a further aspect, the present invention is directed to a system of automated tools that salespersons apply in a sales cycle within an organization to sell goods or services offered by the organization to prospective customers. The system includes a graphical user interface that displays and implements a sales workflow that includes at least a plurality of pre-defined steps of the sales cycle, and a plurality of software tools accessible by the sales person through the graphical user interface that displays and implements the sales workflow. Each of the tools is associated with one of the pre-defined steps of the sales cycle, and includes one or more templates for preparing a communication to a prospective customer being pursued by the sales person. In addition, each tool automatically identifies content needed to effectively execute selling activity based on the pre-defined step associated with the tool.

In accordance with a still further aspect, the present invention is directed to a computer-implemented web portal for automatically managing interactions relating to a prospective sales transaction between a selling organization and a prospective customer organization. The portal comprises a secure web site accessible only to members of the selling and prospective customer organizations who are involved in the prospective sales transaction, and at least one posting tool, available to the members of the selling and prospective customer organizations who are involved in the prospective sales transaction, for posting communications relevant to the prospective sales transaction on the secure web site. At least one viewing tool is provided, and made available to the members of the selling and prospective customer organizations who are involved in the prospective sales transaction, for viewing documents posted on the secure web site using the posting tool. The viewing tool displays posted documents stored in different formats to the members without requiring the members to access underlying programs used to generate the posted documents. The portal further includes at least one communication management tool that stores electronic communications between members of the selling and prospective customer organizations relating to the prospective sales transaction, and provides functionality for displaying past communications relating to the prospective sales transaction. At least one monitoring tool is provided, and made accessible only to members of the selling organization, for monitoring actions taken by members of the prospective customer organization using the secure web site.

In accordance with an additional aspect, the present invention is directed to an automated system that defines and implements the sales cycle applied by salespersons within an organization to sell goods or services offered by the organization to prospective customers. The system includes a graphical user interface that displays a sales workflow that includes at least a plurality of pre-defined steps of the sales cycle, and a software tool, accessible upon request by the sales person through the graphical user interface, that provides the sales person with expert internal and external guidance for completing one or more of the pre-defined steps of the sales cycle. The software tool automatically configures the expert guidance based on the pre-defined step of the sales cycle that the sales person is attempting to complete.

In accordance with yet a further aspect, the present invention is directed to an automated system that defines, implements and tracks the sales cycle applied by salespersons within an organization to sell goods or services offered by the organization to prospective customers. The system includes a graphical user interface that displays to each sales person a sales workflow that includes at least a plurality of pre-defined steps of the sales cycle, and a completion status of each of the pre-defined steps with respect to each sales opportunity being pursued by the salesperson. The graphical user interface also displays to a manager of each sales person a consolidated display of the completion status of a group of sales opportunities being pursued by such sales person and automatically computes the probability or confidence level of a sales opportunity and the likely time to close the sales opportunity based on historical data and weights assigned to activities in the sales cycle.

In accordance with a further embodiment, the present invention is directed to an automated system that defines and implements the sales cycle applied by salespersons within an organization to sell goods or services offered by the organization to a prospective customer organization. The system includes a graphical user interface that displays a sales workflow that includes at least a plurality of pre-defined steps of the sales cycle, and a software tool that automatically provides one or more alerts relevant to the prospective sales opportunity to the sales person through the graphical user interface when a member of the prospective customer organization accesses a document previously made available by the sales person.

In accordance with a still further embodiment, the present invention is directed to an automated system that defines, implements and tracks the sales cycle applied by salespersons within an organization to sell goods or services offered by the organization to prospective customers. The system includes a graphical user interface that displays to each sales person a sales workflow that includes at least a plurality of pre-defined steps of the sales cycle, and a completion status of each of the pre-defined steps with respect to each sales opportunity being pursued by the salesperson. The system collects in a library documents and content created and customized throughout the sales cycle, tags the documents and content stored in the library, and makes the documents and content from the library available to the salesperson at the appropriate stage of the selling cycle. The library includes documents that recommend suggestions and best practices for completing activities in the sales cycle. The system automatically designates a document stored in a library as a best practice based on the frequency of the usage of the document and the relationship of the document to successful sales.

### BRIEF DESCRIPTION OF THE DRAWINGS

FIG. 1 depicts a dashboard screen of a graphical-user interface for implementing the present invention.

FIG. 2 depicts a user homepage screen of the graphical-user interface of the present invention.

FIG. 3 depicts a user selected Opportunity Overview screen of the graphical-user interface of the present invention.

FIG. 4 depicts a Deal Profile screen of the graphical-user interface of the present invention.

FIG. 5 depicts a Buyer Downloads and Comments screen of the graphical-user interface of the present invention.

FIG. 6 depicts an Opportunity Contacts screen of the graphical-user interface of the present invention.

FIG. 7 depicts a Team and Partners screen of the graphical-user interface of the present invention.

FIGS. 8A and 8B depict the use of a Smart Tool to automatically generate a Needs Assessment Document for a sales opportunity.

FIG. 8C depicts the use of a Smart Tool to automatically generate a Product Datasheet for a sales Opportunity.

FIG. 8D depicts the use of a Smart Tool to automatically create e-mails for a sales Opportunity.

FIG. 8E depicts the use of a Smart Tool to automatically generate a package of documents for a sales Opportunity.

FIGS. 8F-8G depict a package of documents generated using the tool shown in FIG. 8E.

FIG. 8H depicts the use of a Smart Tool to automatically create an Elevator Pitch for a sales Opportunity.

FIG. 9A shows a screen of the graphical user interface that identifies web search engines that are used to automatically identify news updates relevant to the sales Opportunity.

FIG. 9B shows a screen of the graphical user interface that lists news updates that have been automatically generated and which are relevant to the sales Opportunity.

FIG. 10 depicts a portion of the graphical user-interface used for implementing the Qualify phase (or step) of the sales cycle.

FIGS. 11A, 11B, 11C, 11D and 11E depict portions of the graphical user-interface used for implementing the Qualify phase (or step) of the sales cycle.

FIG. 12 depicts a portion of the graphical user-interface used for implementing the Qualify phase (or step) of the sales cycle.

FIG. 13 depicts a portion of the graphical user-interface used for implementing the Consult phase (or step) of the sales cycle.

FIGS. 14A and 14B depict portions of the graphical user-interface used for implementing the Consult phase (or step) of the sales cycle.

FIGS. 15-16 depict portions of the graphical user-interface used for implementing the Validate phase (or step) of the sales cycle.

FIG. 17 depicts the portion of the graphical user-interface used for implementing the Propose phase (or step) of the sales cycle.

FIG. 18 depicts the portion of the graphical user-interface used for implementing the Close phase (or step) of the sales cycle.

FIGS. 19-20 depict screens of the graphical-user interface used for creating, searching and editing customer account information.

FIGS. 21-23 depict screens of the graphical-user interface used for creating, searching, viewing, marking and editing Opportunities.

FIG. 24 depicts a screen of the graphical-user interface used for detailing files and documents collected in a repository type folder during the sales cycle for a particular opportunity, and packaged for a buyer to view and comment upon.

FIG. 25 depicts a screen of the graphical-user interface used for accessing a portal where a member of the buyer organization can log in and view files and information placed by the seller organization.

FIGS. 26-29 depict screen shots of the web portal, where a member of the buyer organization can log in and view files and information placed by the seller organization.

FIG. 30 depicts a screen of the graphical-user interface showing a library that collect documents and content created and customized throughout the sales cycle, tags them and makes them available in the sales process.

FIG. 31 depicts a screen of the graphical-user interface where a member of the selling organization obtains Expert Guidance and Management Insight.

FIGS. 32-36 depict screens of a dash board that provides Sales Reps, Sales Managers, and Senior Executives with a tool to assess the health of their sales.

### DETAILED DESCRIPTION OF THE PREFERRED EMBODIMENTS

The accompanying drawings, which are incorporated herein and constitute part of this specification, illustrate presently preferred embodiments of the invention, and, together with the general description given above and the detailed description given below, serve to explain features of the invention. The screens shown in the accompanying Figures illustrate an example of how the automated systems of the present invention may be implemented. The screen shots are intended to be exemplary only, and are not intended as limiting the scope of the invention to the particular embodiment shown.

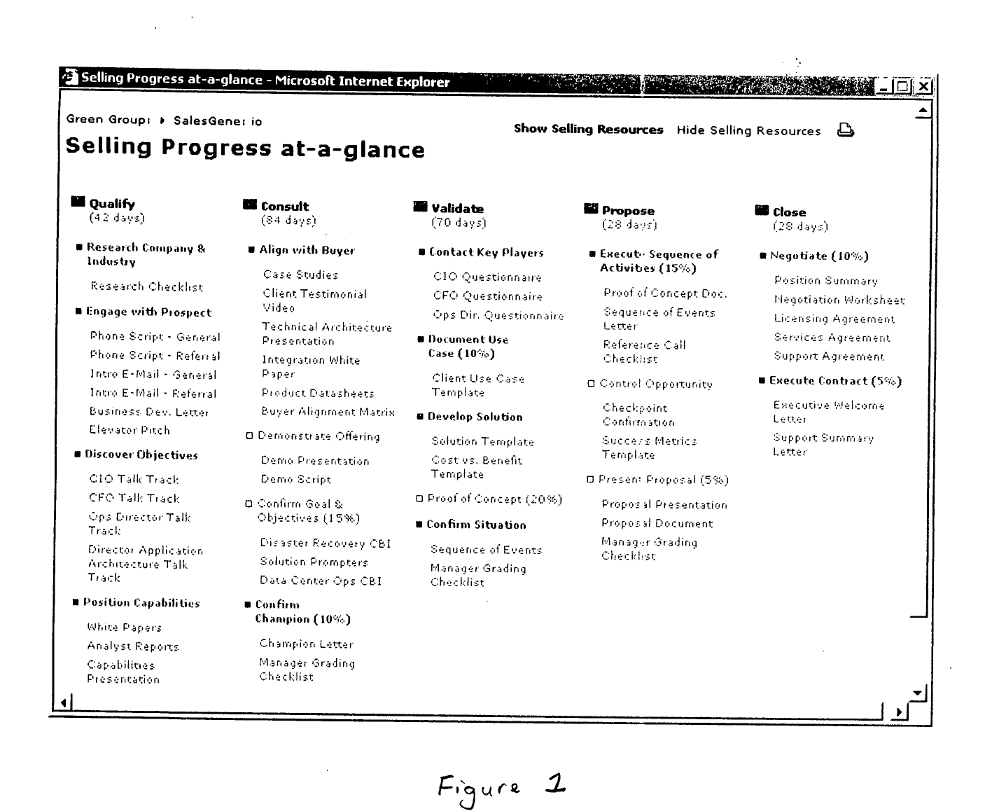

FIG. 1 depicts a dashboard screen of a graphical-user interface for implementing the present invention. The dashboard depicts sales processes, activities and reports. Each phase or process in the sales cycle of a selling organization has a corresponding selling process represented on the dashboard. The selling process represented on the dashboard can be defined by the selling organization. In the example of FIG. 1, the selling process is defined to include the following phases: Qualify, Consult, Validate, Propose and Close. Each phase includes several Activities and Sub-Activities, as well as Tools for accomplishing the Activities and Sub-Activities.

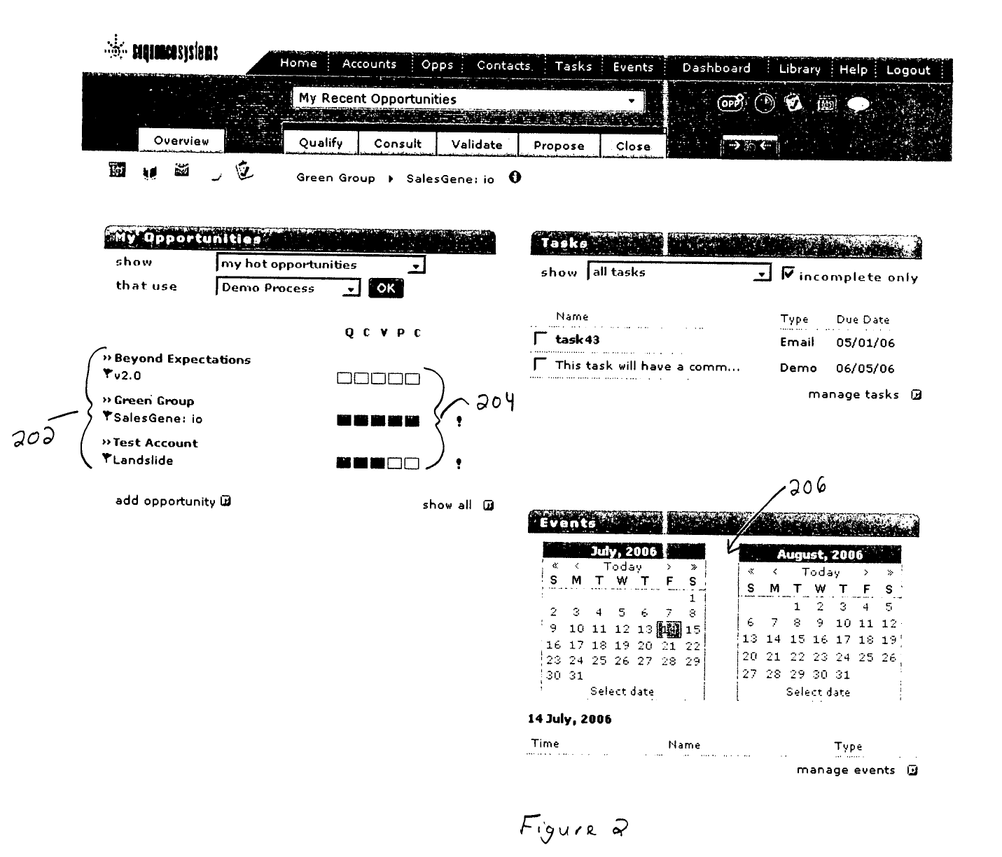

FIG. 2 depicts a user homepage screen of the graphical-user interface of the present invention. The user homepage depicts opportunities 202 at a glance with a status depiction 204 of the stages and activities that are being undertaken for each opportunity. The user homepage screen includes a section for tracking tasks and a calendar scheduler section 206. From this screen, a user can select an opportunity, add an opportunity or search/add an account.

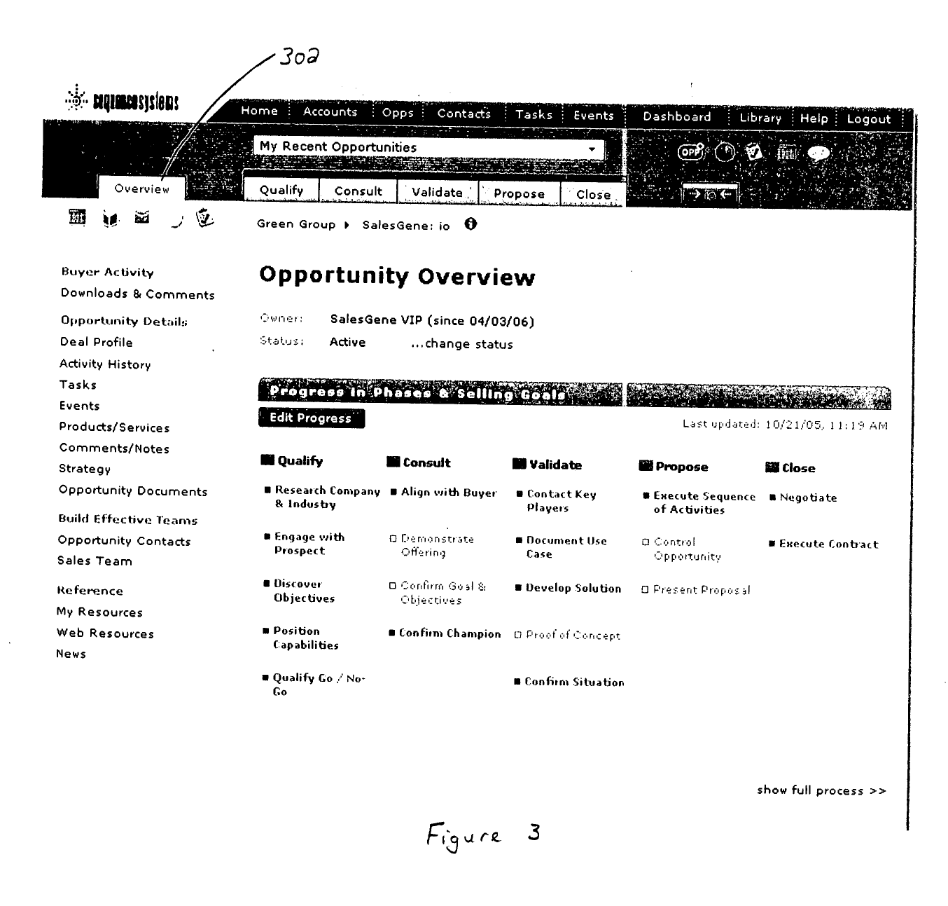

FIG. 3 depicts a user selected Opportunity Overview screen of the graphical-user interface of the present invention. The user selected opportunity overview screen depicts phase or process status, generated automatically upon completion (via the graphical user interface) of specific milestones in the sales cycle. The screen includes an overview tab 302 with links for displaying elemental details of the sales opportunity including the deal size and dates, team Members (i.e., buyer and seller team members associated with the opportunity), and pertinent documents/references from various resources (e.g., the library integrated with the graphical user interface). News updates relevant to the sales opportunity that are automatically generated using Web Search engines may be accessed by the user by clicking on the news link on overview tab 302. Alerts that have been automatically generated or manually created by members of the buying or selling teams may be accessed by the user by clicking on the Buyer Activity-Download & Comment link on overview tab 302.

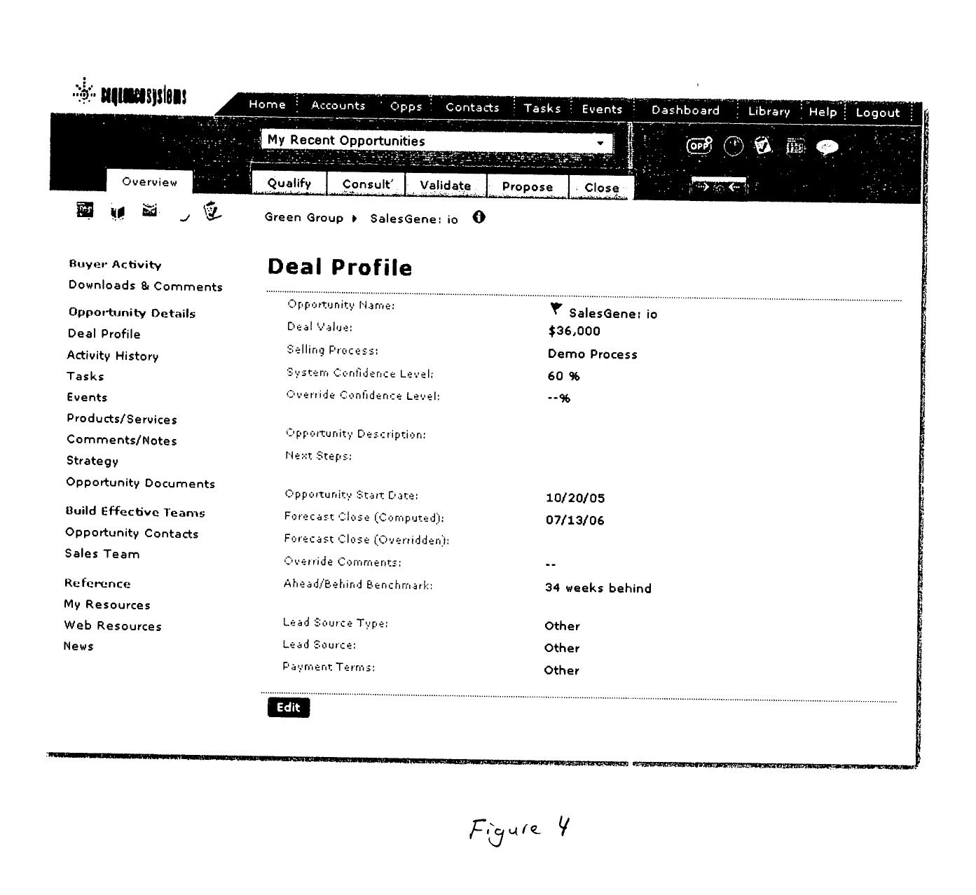

FIG. 4 depicts a Deal Profile screen of the graphical-user interface of the present invention. The Deal Profile screen is accessed using the “Deal Profile” link in overview tab 302, and displays, among other things, the deal size, a confidence value that the deal will close and scheduling information.

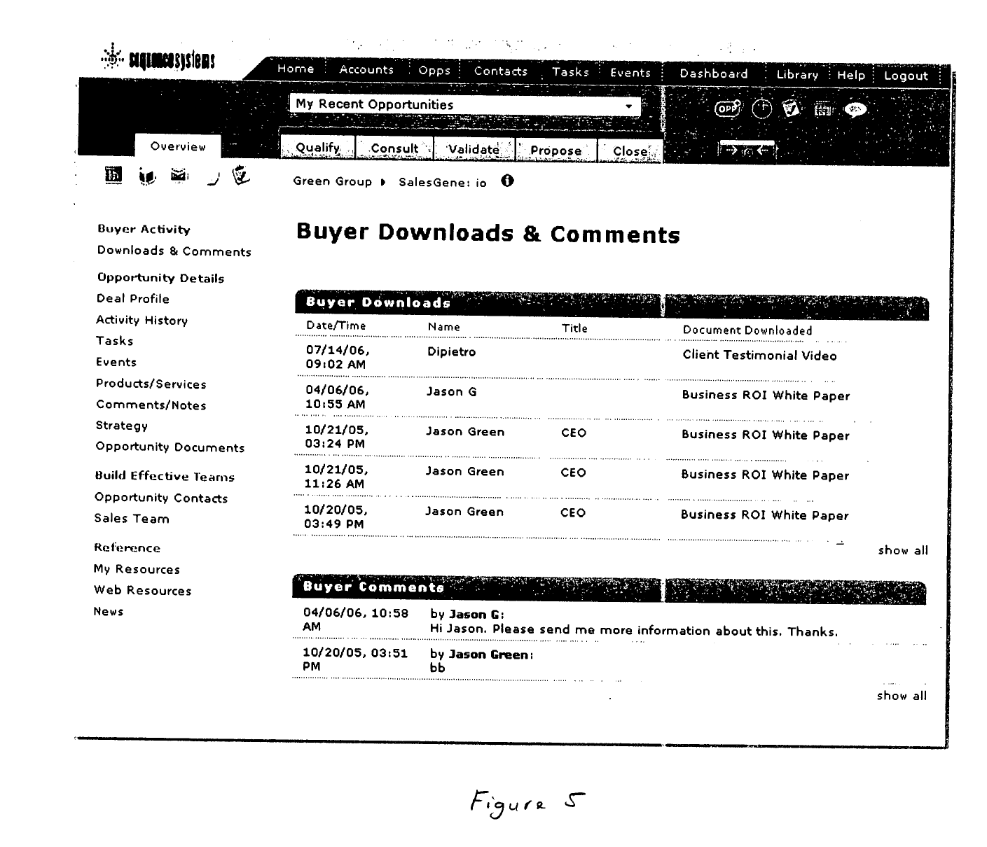

FIG. 5 depicts a Buyer Downloads and Comments screen of the graphical-user interface of the present invention. The Buyer Download and Comments screen is accessed using the “Downloads and Comments” link in overview tab 302, and identifies documents previously downloaded by the buyer (from the sales portal, discussed below) and comments provided by the buyer during the sales process.

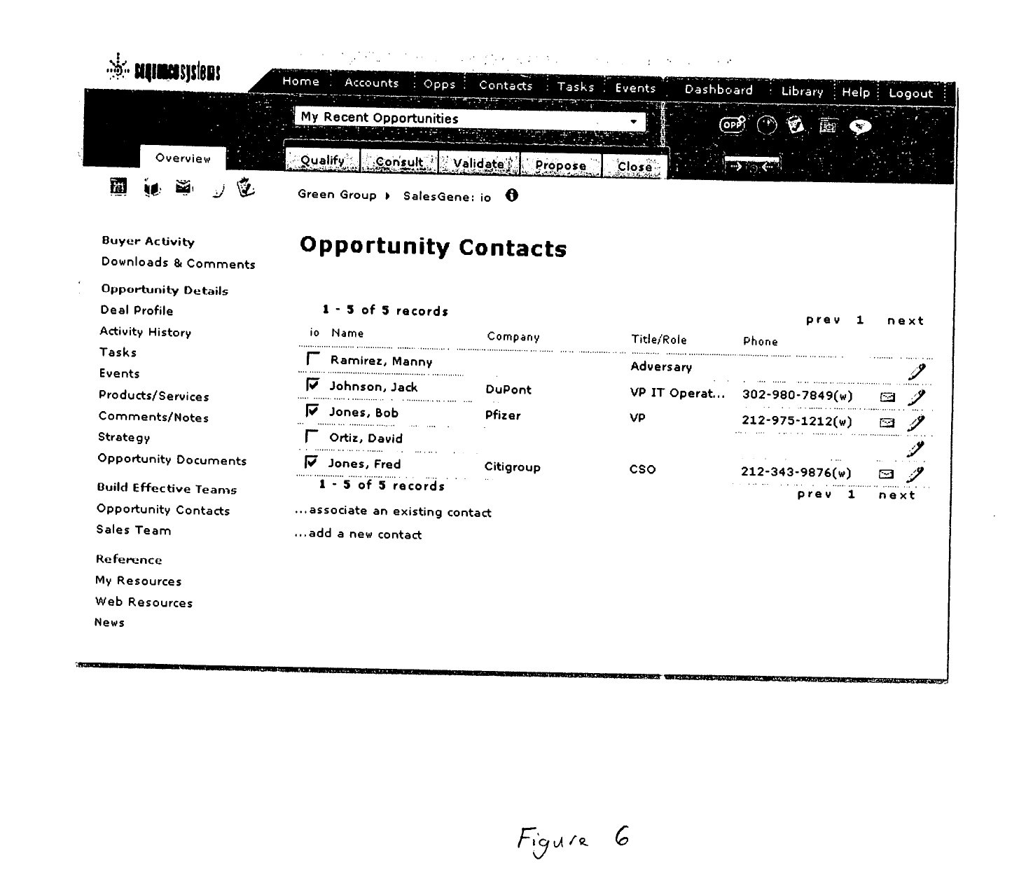

FIG. 6 depicts an Opportunity Contacts screen of the graphical-user interface of the present invention. The Opportunity Contacts screen is accessed using the “Opportunities Contact” link in overview tab 302, and identifies contact information for persons at the buyer organizations that are the subject of opportunities being tracked by the system.

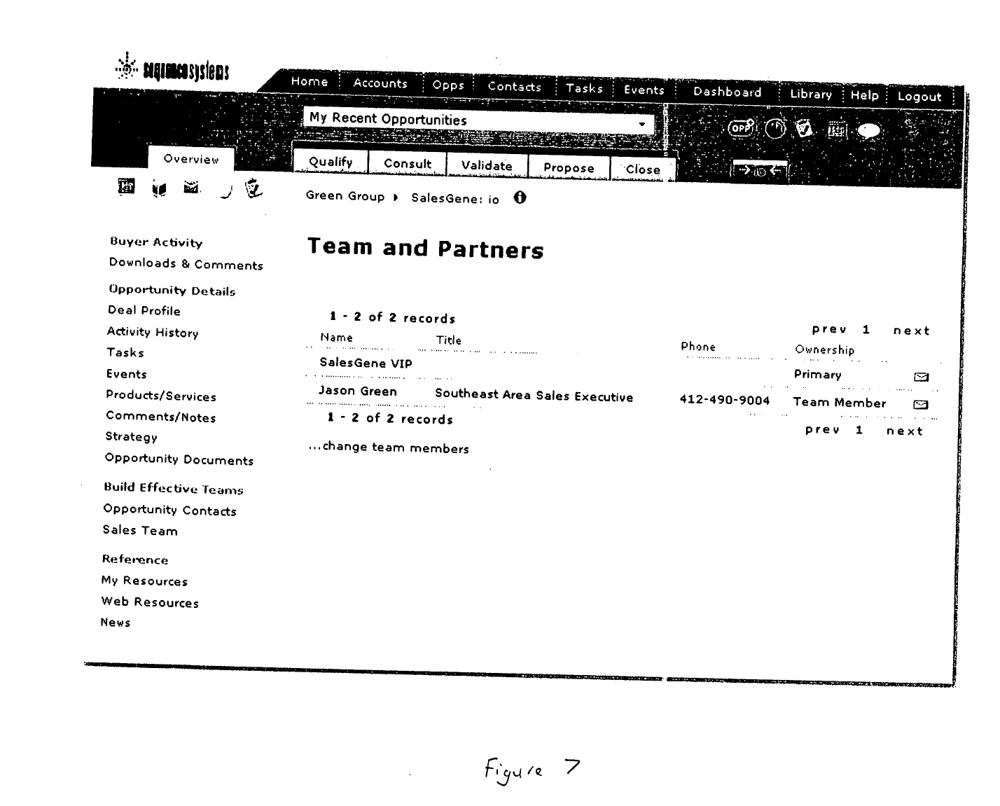

FIG. 7 depicts a Team and Partners screen of the graphical-user interface of the present invention. The Team and Partners screen is accessed using the “Sales Team” link in overview tab 302, and identifies contact information for persons at the selling organization that are participating in the opportunity being tracked by the system.

As mentioned above, the present invention includes a system of automated tools (referred to below as “Smart Tools”) that salespersons apply in a sales cycle within an organization to sell goods or services offered by the organization to prospective customers. Each of the tools is associated with one of the pre-defined steps of the sales cycle (e.g., Qualify, Consult, Validate, Propose or Close), and includes one or more templates for preparing a communication to a prospective customer being pursued by the sales person. In addition, each tool automatically identifies content needed to effectively execute selling activity based on the pre-defined step associated with the tool.

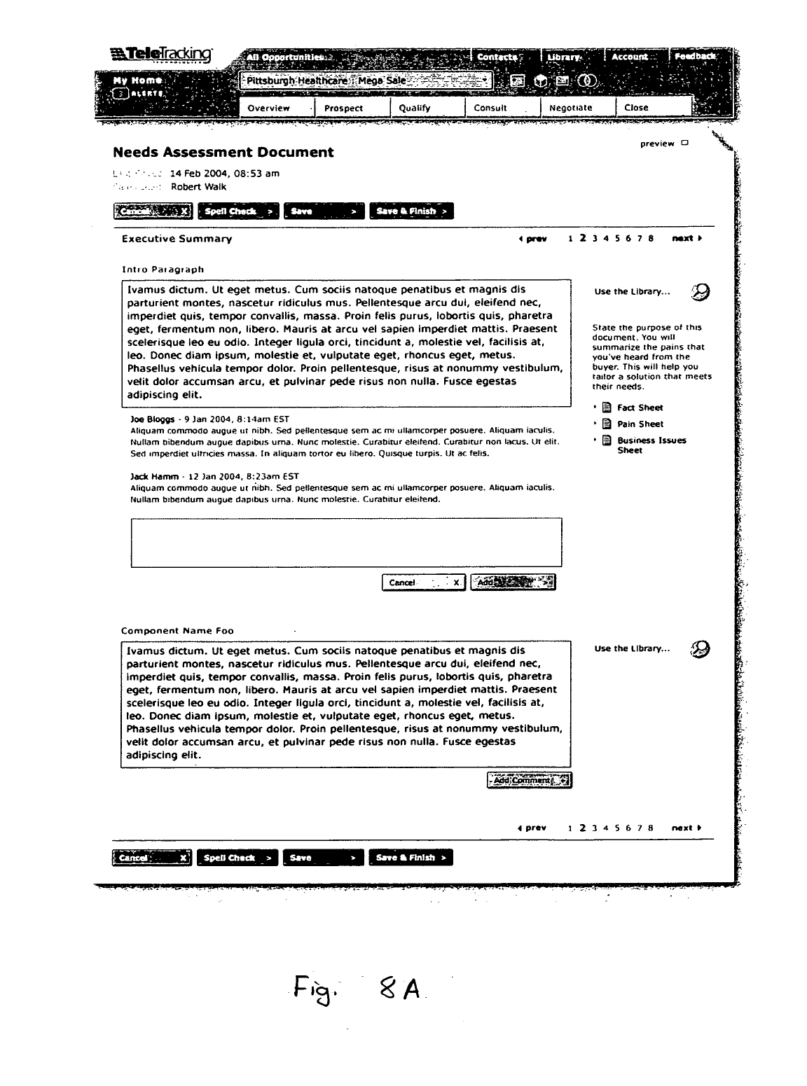

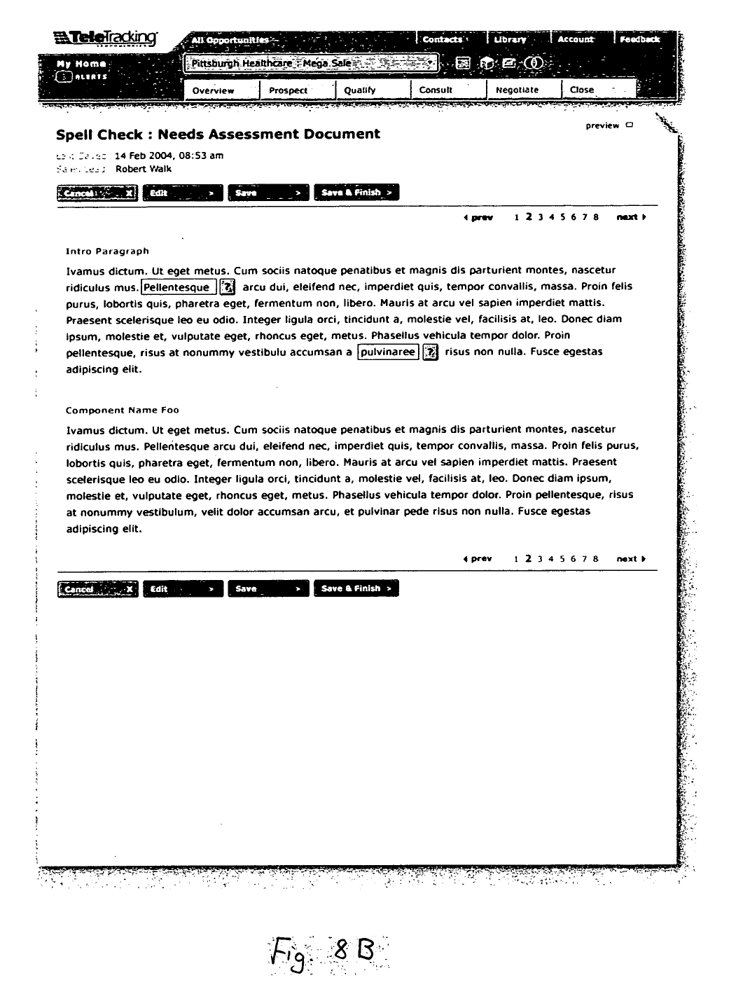

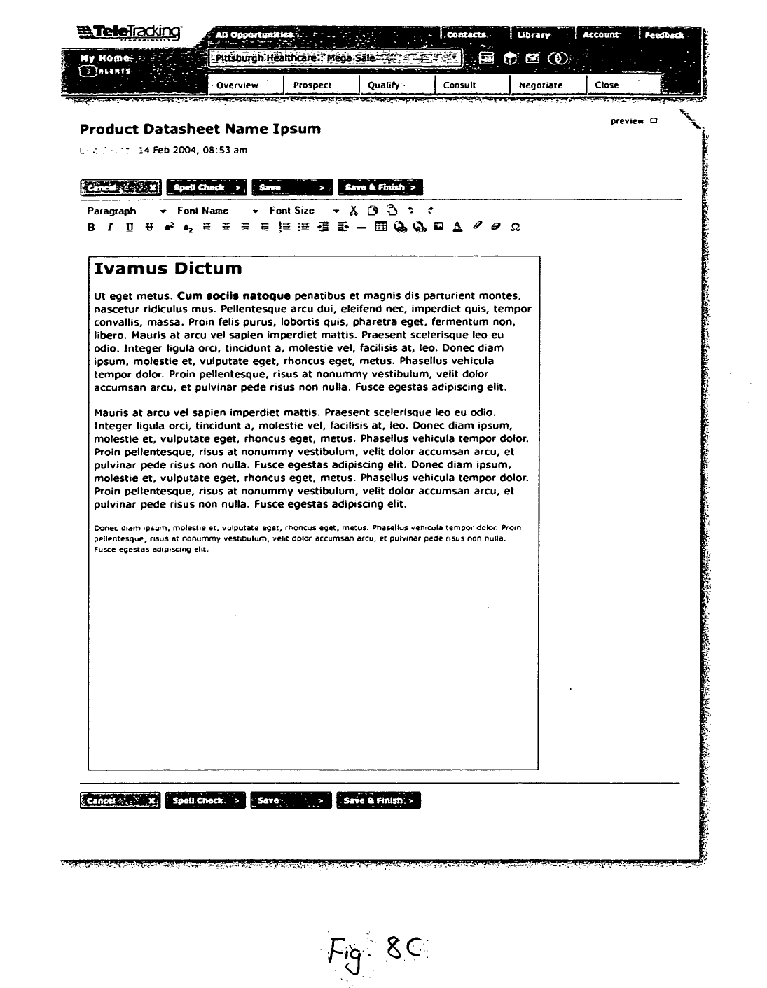

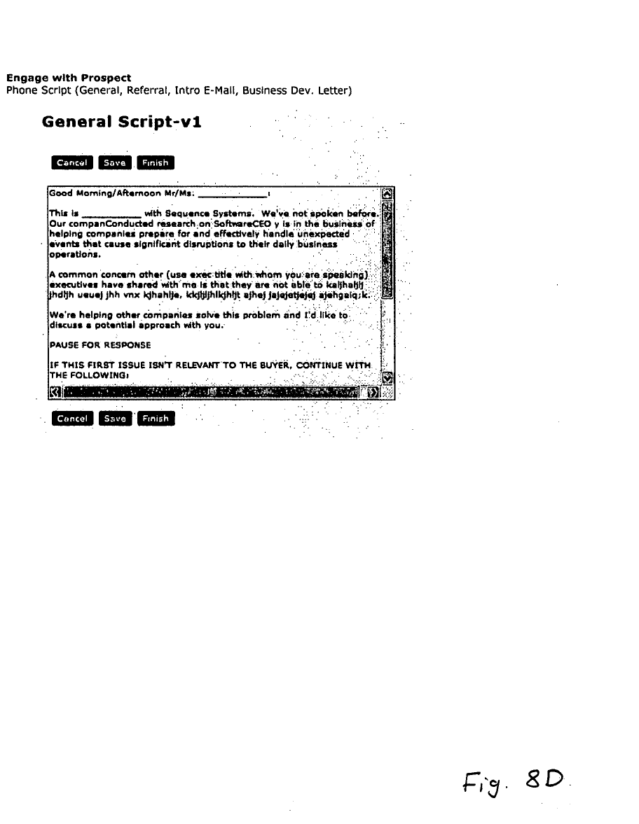

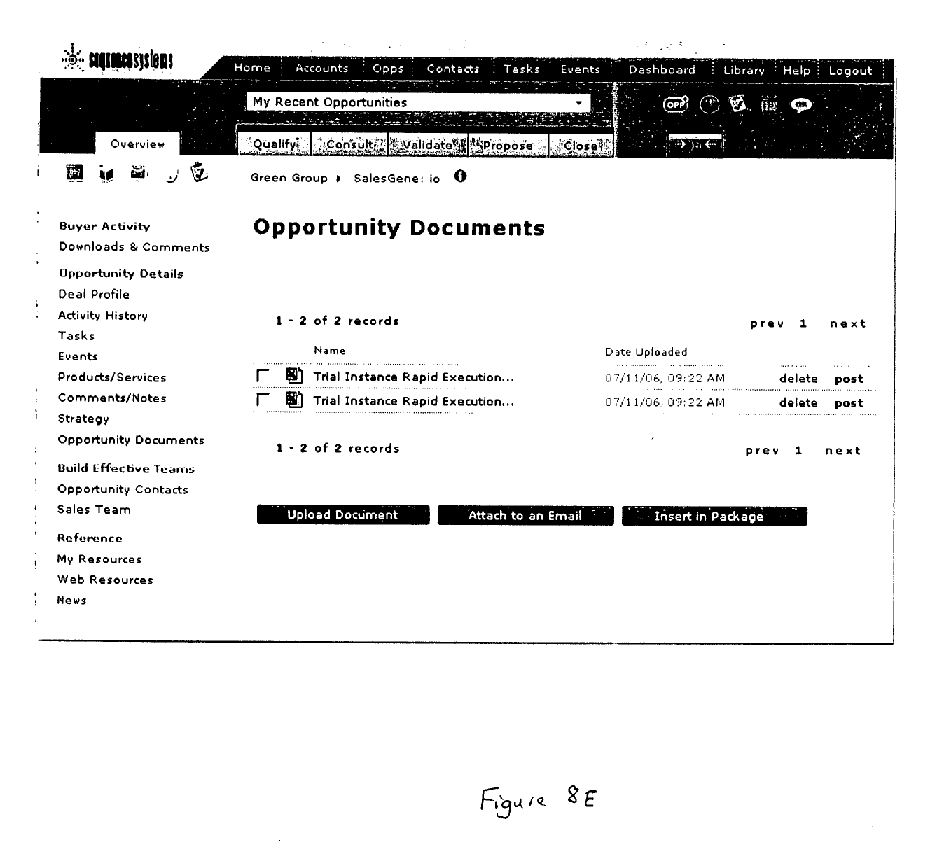

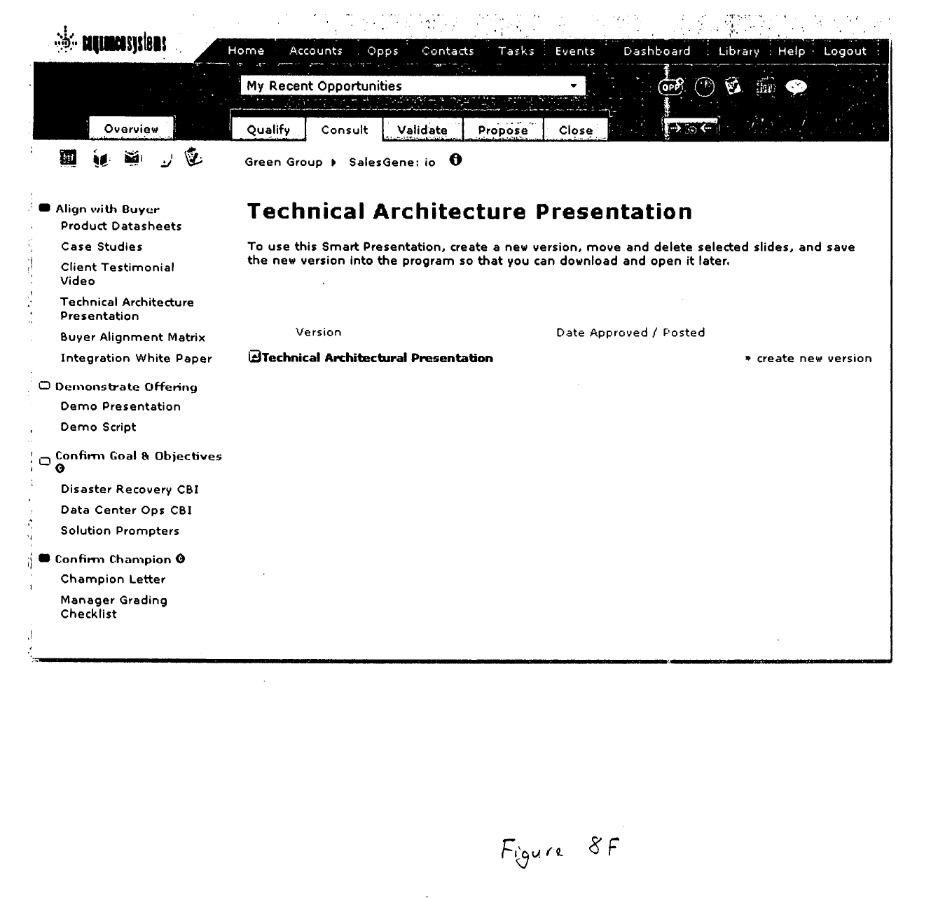

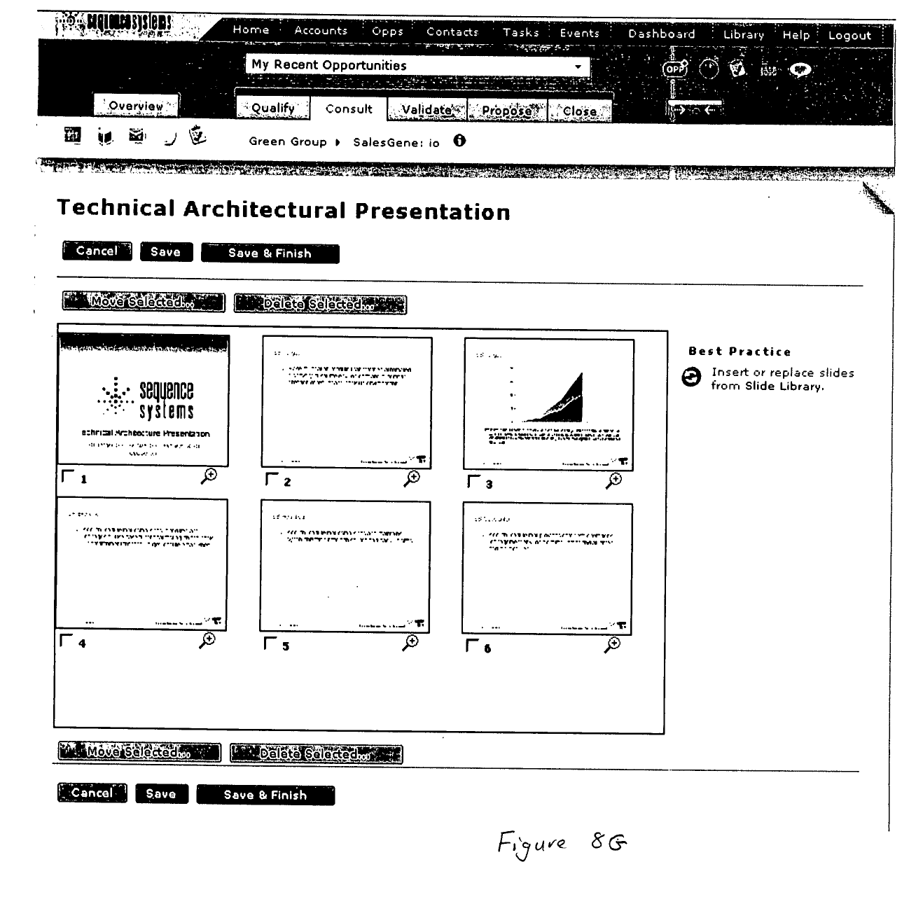

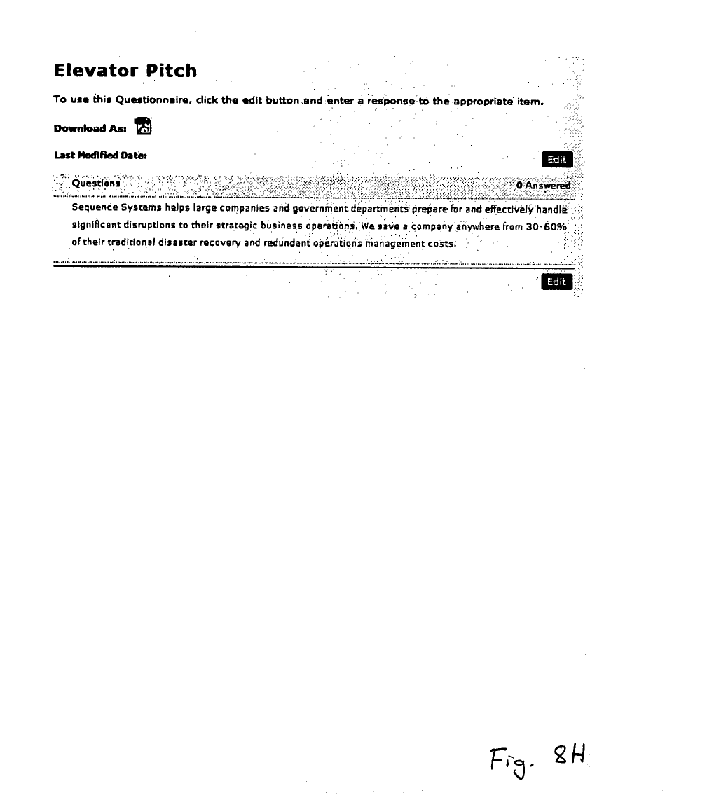

FIGS. 8A-8H illustrate examples of Smart Tools integrated into the graphical user interface of the present invention. The Smart Tools are automatically assigned and aligned within the selling activities and may be editable. Once uploaded these files can be packaged, e-mailed or posted into the web portal (discussed below) for automatically managing interactions relating to a prospective sales transaction. The graphical user interface automatically tracks the sending/posting of all documents/e-mails created using the Smart Tools, and uses the tracking information to automatically generate a completion status for each step in the sales cycle. Documents created using the Smart Tools can also be tagged and stored in the system library for use in future sales opportunities.

FIGS. 8A-8B depict the use of a Smart Tool to automatically generate a Needs Assessment Document for a sales opportunity. This tool is associated with one of the pre-defined steps of the sales cycle, and includes a template for preparing the Needs Assessment Document. This tool automatically identifies content needed to generate the Needs Assessment Document from information about the sales opportunity previously input into the system. Information in the library (discussed below) may also be used for automatically generating portions of the Needs Assessment Document. The graphical user interface shown in FIGS. 8A-8B includes functionality for spell checking, editing and saving the Needs Assessment Document. The graphical user interface also includes functionality that permits members of the sales team to comment on the Needs Assessment Document.

FIG. 8C depicts the use of a Smart Tool to automatically generate a Product Datasheet for a sales opportunity. This tool is associated with one of the pre-defined steps of the sales cycle, and includes a template for preparing the Product Datasheet. This tool automatically identifies content needed to generate the Product Datasheet from information about the sales opportunity previously input into the system. Information in the library (discussed below) may also be used for automatically generating portions of the Product Datasheet. The graphical user interface for the Product Datasheet includes functionality for spell checking, editing and saving the Product Datasheet.

FIG. 8D depicts the use of a Smart Tool to automatically create a Generate Interest E-mail for a sales opportunity. This tool is associated with one of the pre-defined steps of the sales cycle (i.e., the Qualify step), and includes a template for preparing the Generate Interest E-mail (e.g., either the Intro E-mail-General or Intro-E-mail Referral discussed below in connection with the Qualify step). This tool automatically identifies content needed to create the Generate Interest E-mail from information about the sales opportunity previously input into the system. Information in the library (discussed below) may also be used for automatically creating portions of the Generate Interest E-mail. The content automatically identified for the e-mail may then be edited and/or saved by the sales person in order to finalize the Generate Interest E-mail. The Phone Script-General, Phone Script Referral and Business Development Letter (all shown below in connection with the Qualify step) are generated using a Smart Tool that is similar to the one shown in FIG. 8E, but configured for generating either a phone script or business development letter.

FIG. 8E depicts the use of a Smart Tool to automatically generate a package of documents for a sales opportunity. This tool is associated with one of the pre-defined steps of the sales cycle, and includes a template for preparing the package. In this example, the template corresponds to a template previously stored in the library and designated or tagged as a “best practice.” As with the other Smart Tools, this tool automatically identifies content needed to create the package from information about the sales opportunity previously input into the system. FIGS. 8F-8G depict a package of documents generated using, for example, the tool shown in FIG. 8E. The graphical user interface shown in FIGS. 8F-8G includes functionality for adding, modifying or removing content from the package.

FIG. 8H depicts the use of a Smart Tool to automatically create an Elevator Pitch for a sales opportunity. This tool is associated with one of the pre-defined steps of the sales cycle (i.e., the Qualify step), and includes a template for preparing the Elevator Pitch. In one embodiment, this tool automatically identifies content needed to create the Elevator Pitch from information about the sales opportunity previously input into the system. Information in the library (discussed below) may also be used for automatically creating portions of the Elevator Pitch. The content automatically identified for the pitch may then be edited and/or saved in order to finalize the Elevator Pitch.

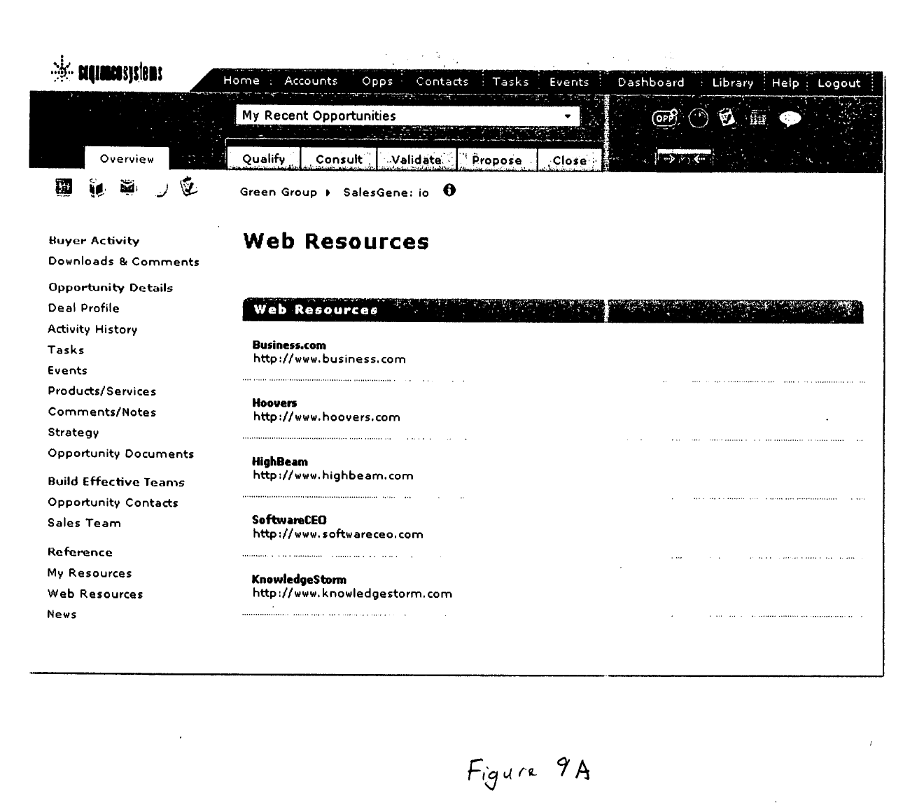

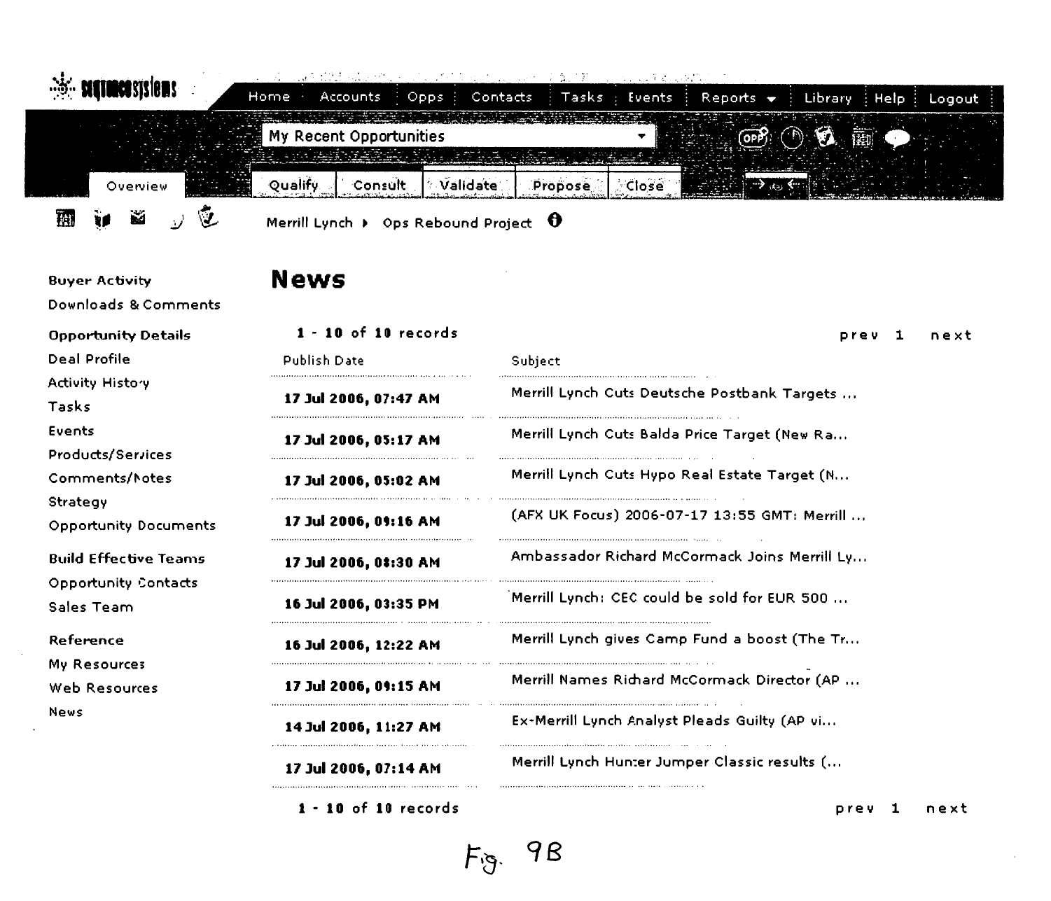

Referring now to FIG. 9A, this screen of the graphical user interface is used to depict web search engines that are used to automatically identify news updates relevant to the sales opportunity. News updates identified by search engines may be provided to the user via the screen shown in FIG. 9B.

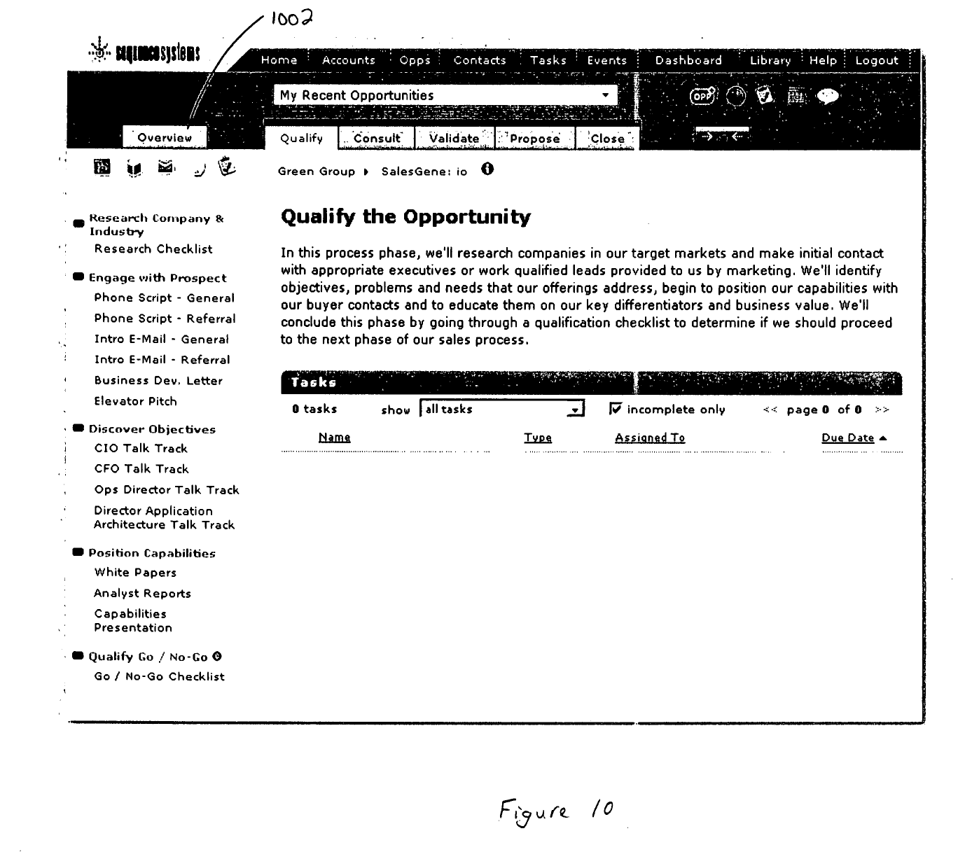

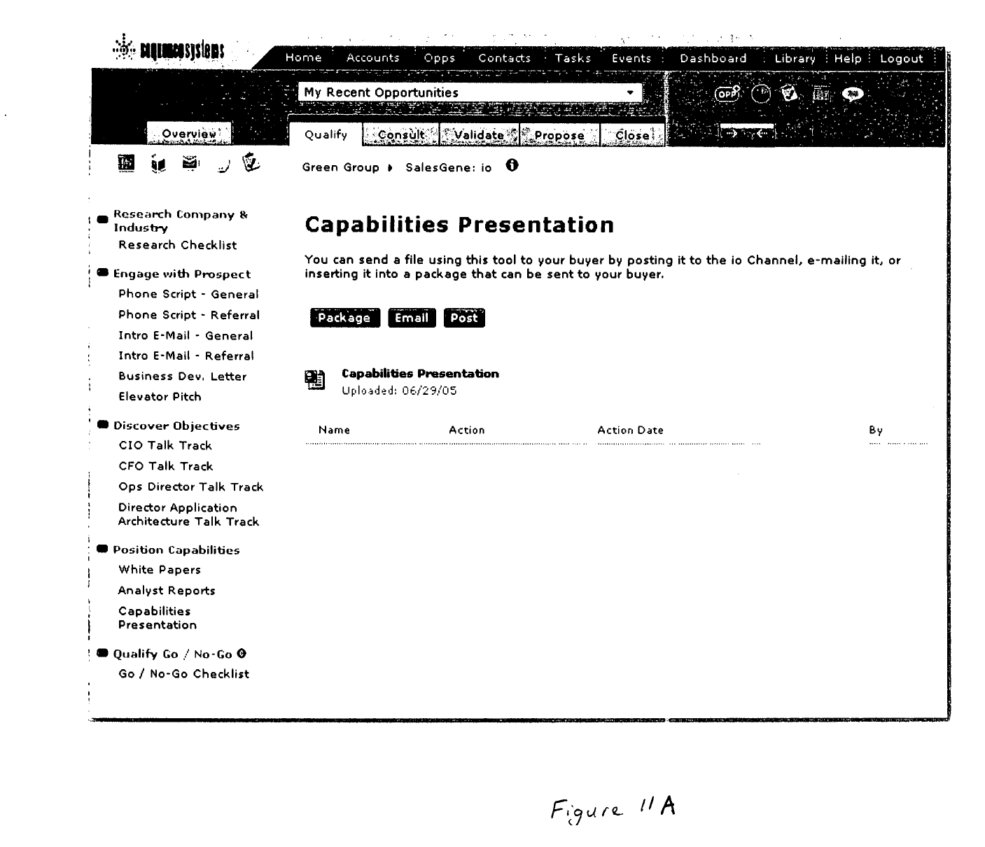

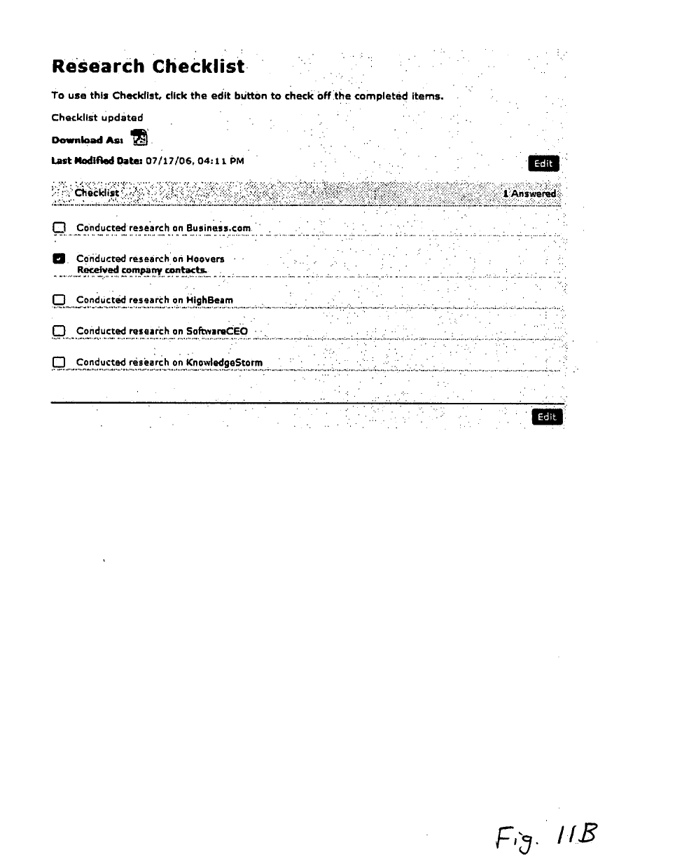

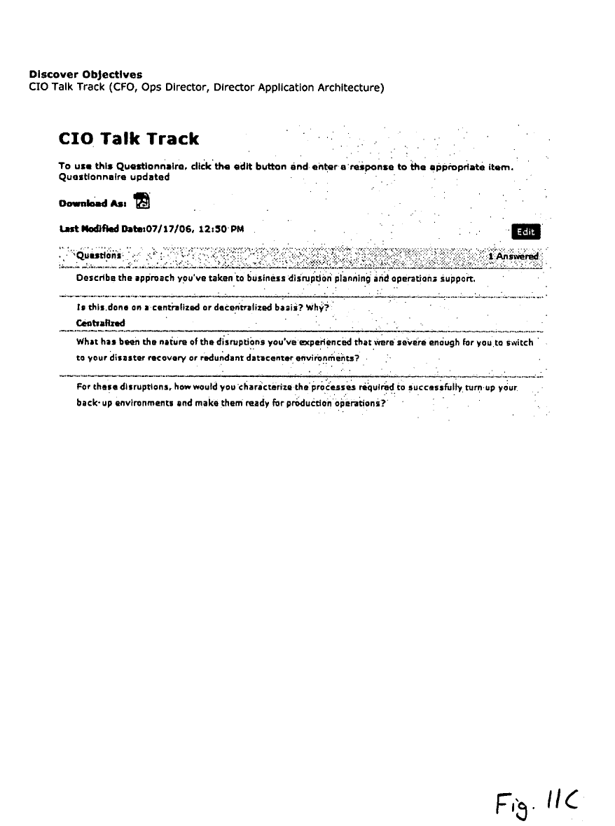

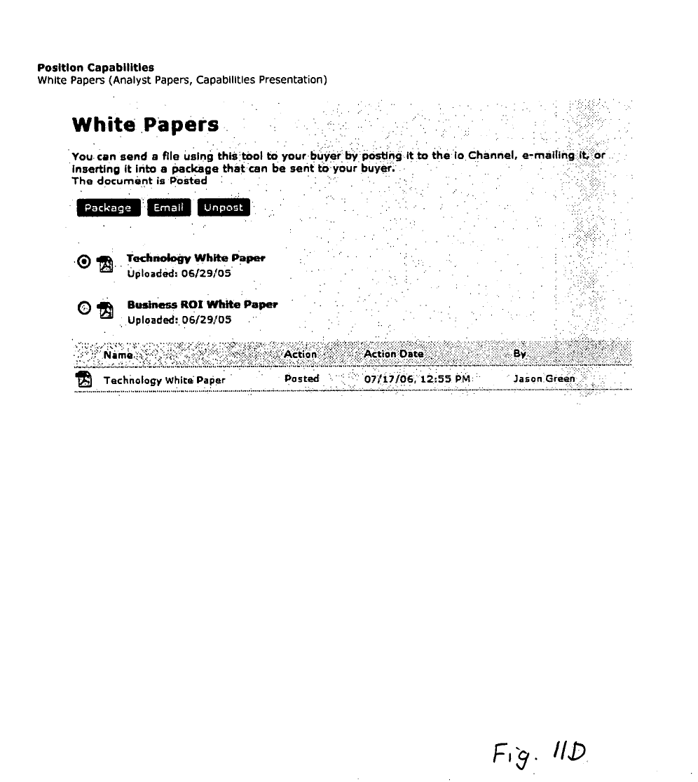

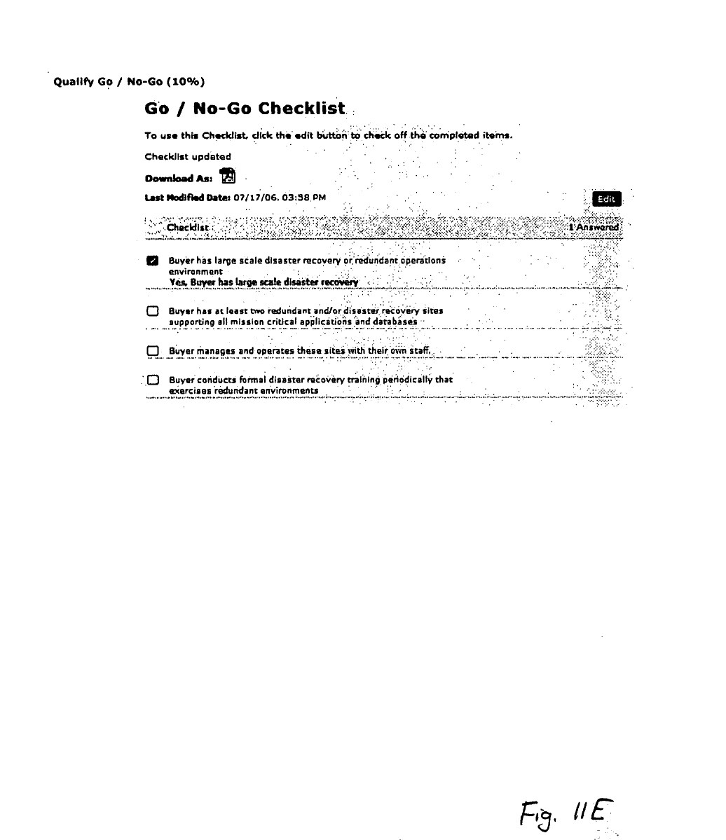

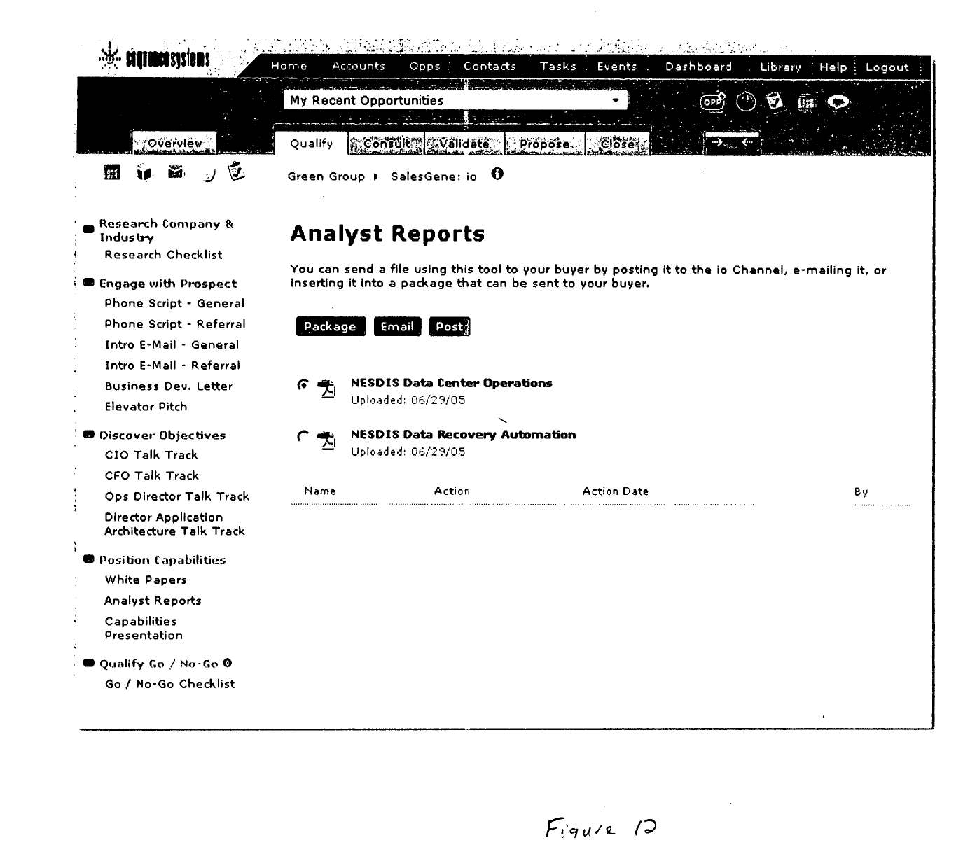

FIGS. 10-12 depict portions of the graphical user-interface used for implementing the Qualify phase (or step) of the sales cycle. This step may be used as a starting point to build a sales pipeline. Note that the Intro E-mail-General, Intro E-Mail Referral, Phone Script-General, Phone Script Referral, and Business Development letter links shown in the overview tab of these screens are used for accessing the Smart Tools discussed above in connection with FIG. 8D, and the Elevator Pitch link is used to access an Elevator Pitch developed using the Smart Tool discussed above in connection with FIG. 8H. Overview tab 1002 identifies the Activities in the Qualify phase, including Research Company and Industry (shown in FIG. 11B), Engage with Prospect (which includes the following Sub-activities: Phone Script-General, Phone Script Referral, Intro E-mail-General, Intro-E-mail Referral, Business Development Letter, and Elevator Pitch), Discover Objective (which includes the following Sub-Activities: CIO Talk Track, CFO Talk Track (shown in FIG. 11C), Ops Director Talk Track, and Director Application Architecture Talk Track), Position Capabilities (which includes the following Sub-Activities: White Paper (shown in FIG. 11D), Analyst Reports (shown in FIG. 12) and Capabilities Presentation (shown in FIG. 11A)) and Qualify Go/No-Go (shown in FIG. 11E). Completion of each of these Activities is tracked by the software and used for generating the completion status information (204) shown in FIG. 2.

Referring specifically to FIG. 11B, a screen used for implementing the Research Checklist Activity is shown. This screen is used to track completion of each step in the Research Company & Industry Activity, which is used to research companies in target markets and begin to qualify leads. Using functionality provided with the software as part of the Research Company & Industry Activity, the salesperson has the ability to have web links to specific websites that can help with discovering more information about the buyer. Also, they have the ability check off which companies they have researched as well as make notes.

Referring specifically to FIG. 11C, a screen used for implementing the CIO Talk Track Activity is shown. This screen provides the sales person with a questionnaire that the salesperson can use during a conversation with the CIO of a buyer organization in order to identify objectives, problems and needs of the buyer, and begin to position the seller's capabilities with the buyer contacts and educate them on differentiators and business value of the product/service being sold. Using the interface shown in FIG. 11C, the salesperson will has the ability to record answers to specific questions to many different key decision makers. All answers are recorded in this section and can be shared and printed from this section. The CFO Talk Track, Ops Director Talk Track and Director Application Architecture Talk Track Activities are accessed using screens substantially the same as the one shown in FIG. 11C, but with questions that would be applicable to a CFO, Ops Director or Director of Application Architecture.

Referring specifically to FIG. 11D, a screen used for implementing the White Paper Activity is shown. This screen provides the sales person with the ability to present white papers relevant to the sales opportunity to appropriate contacts in the buyer organization. Using this screen, the salesperson has the ability to post documents to the portal (described below) or send an email with the White Paper directly from this step in the sales cycle to the buyer organization. Similar screens are used for providing capabilities presentations (FIG. 11A) and Analyst Reports (FIG. 12) to the buyer organization.

Referring specifically to FIG. 11E, a screen used for implementing the Go/No-Go Checklist is shown. This screen provides the sales person with a qualification checklist to determine if the salesperson should proceed to the next phase of the sales process. Using the screen, the salesperson has the ability to check off whether the lead is qualified or not, and to record comments/answers responsive to each of the topics set forth on the checklist.

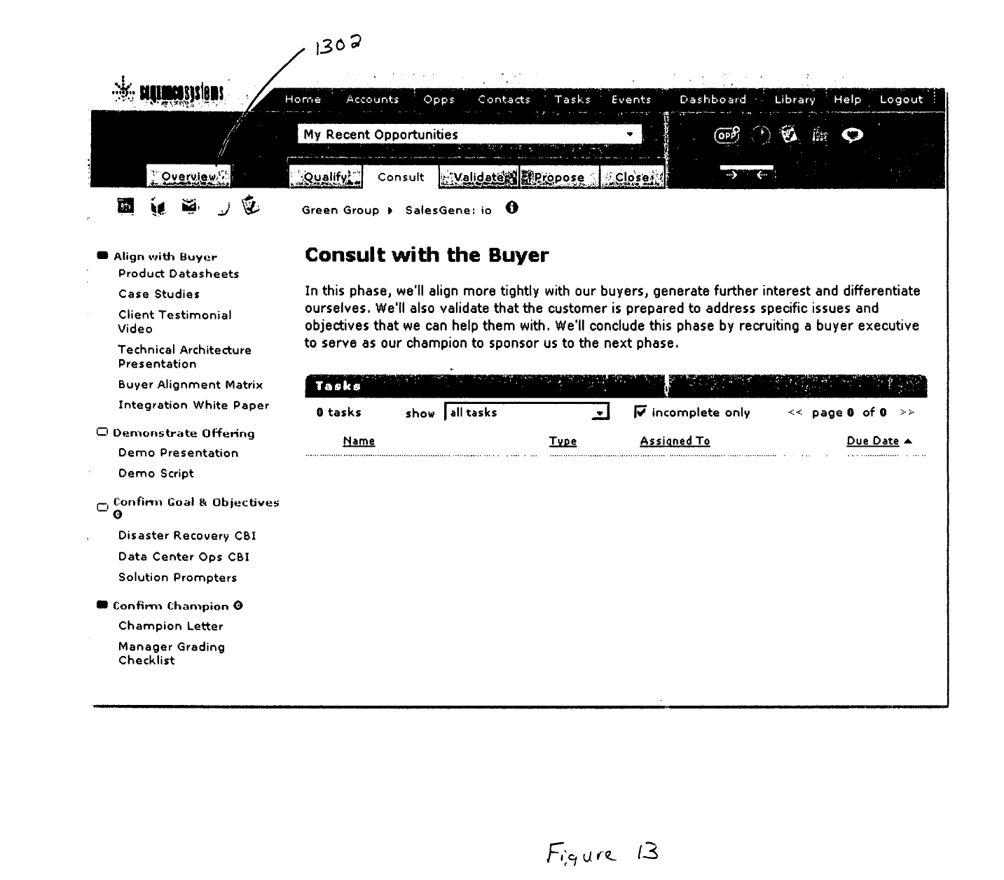

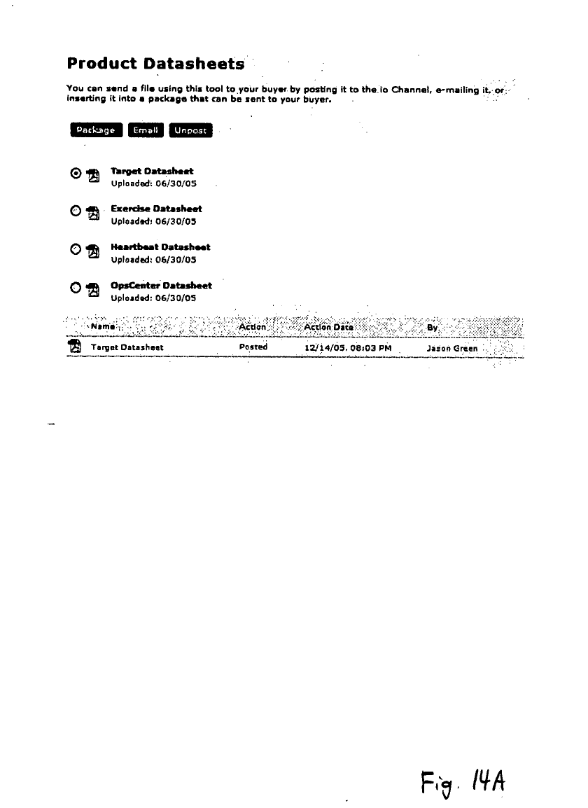

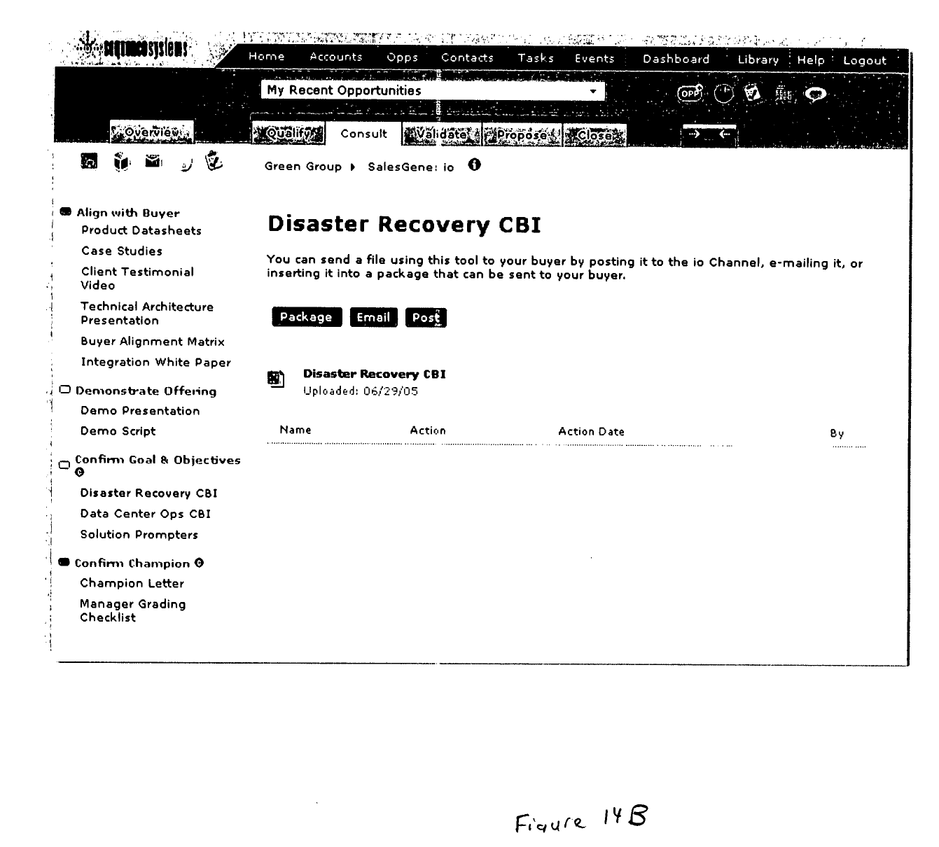

FIGS. 13-14 depict portions of the graphical user-interface used for implementing the Consult phase (or step) of the sales cycle. This step is used to develop a specific value proposition for a sales opportunity. Note that the product datasheets (shown in connection with FIG. 14A) and the package (e.g., Disaster Recovery CBI shown in connection with FIG. 14B) may be generated using the Smart Tools discussed above. Overview tab 1302 identifies the Activities in the Consult phase, including Align with Buyer (which includes the following Sub-Activities: Product Datasheets, Case Studies, Client Testimonial Video, Technical Architecture Presentation, Buyer Alignment Matrix, and Integration White Paper), Demonstrate Offering (which includes the following Sub-Activities: Demo Presentation and Demo Script), Confirm Goal & Objectives (which includes the following Sub-Activities: Disaster Recovery CBI, Data Center Ops CBI and Solution Prompters) and Confirm Champion (which includes the following Sub-Activities: Champion Letter and Manager Grading Checklist). Completion of each of these Activities is tracked by the software and used for generating the completion status information (204) shown in FIG. 2.

Referring to the Activities shown in tab 1302 for the Consult phase of the selling process, the links under the “Align With Buyer” heading are used to more tightly align buyers with a sales opportunity and provide them more documents or information that will help them make a better buying decision. Using the links shown under the “Align With Buyer” heading, the salesperson has many options for posting to the portal (discussed below) or e-mailing directly to the buyer organization any of the following: Product Data Sheets, a Client Testimonial Videos, or a Technical Architecture Presentation (such as the one shown in FIG. 5G). The screen shown in FIG. 14A is used for posting Product Datasheets to the portal (discussed below) or e-mailing them directly to the buyer organization. Similar screens (not shown) are used for posting Client Testimonial Videos or presentations to the portal (discussed below) or e-mailing them directly to the buyer organization in this phase of the selling process.

Referring still to the Activities shown in tab 1302 for the Consult phase of the selling process, the links under the “Demonstrate Offering” heading provide the salesperson with functionality to view, email, or post a presentation to the buyer. The salesperson will have the option to create and edit slides for a presentation to the buyer by accessing the links under this heading. The links under the “Confirm Goal & Objectives” heading provide the salesperson with functionality for: (i) asking the buyer more questions in order to confirm goals and objectives of the buyer, and (ii) preparing to address specific issues and objectives of the buyer. The links under the “Confirm Champion” heading provide the salesperson with functionality for recruiting a buyer executive to serve as a champion to sponsor the selling opportunity in the next phase of the sales process.

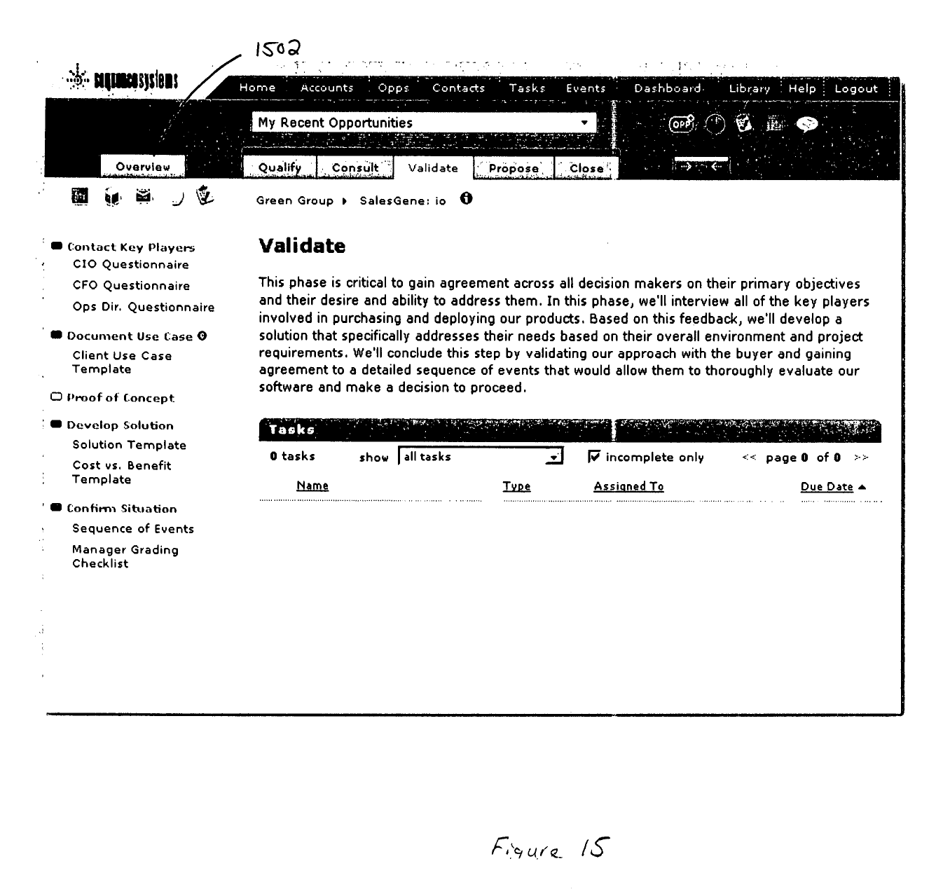

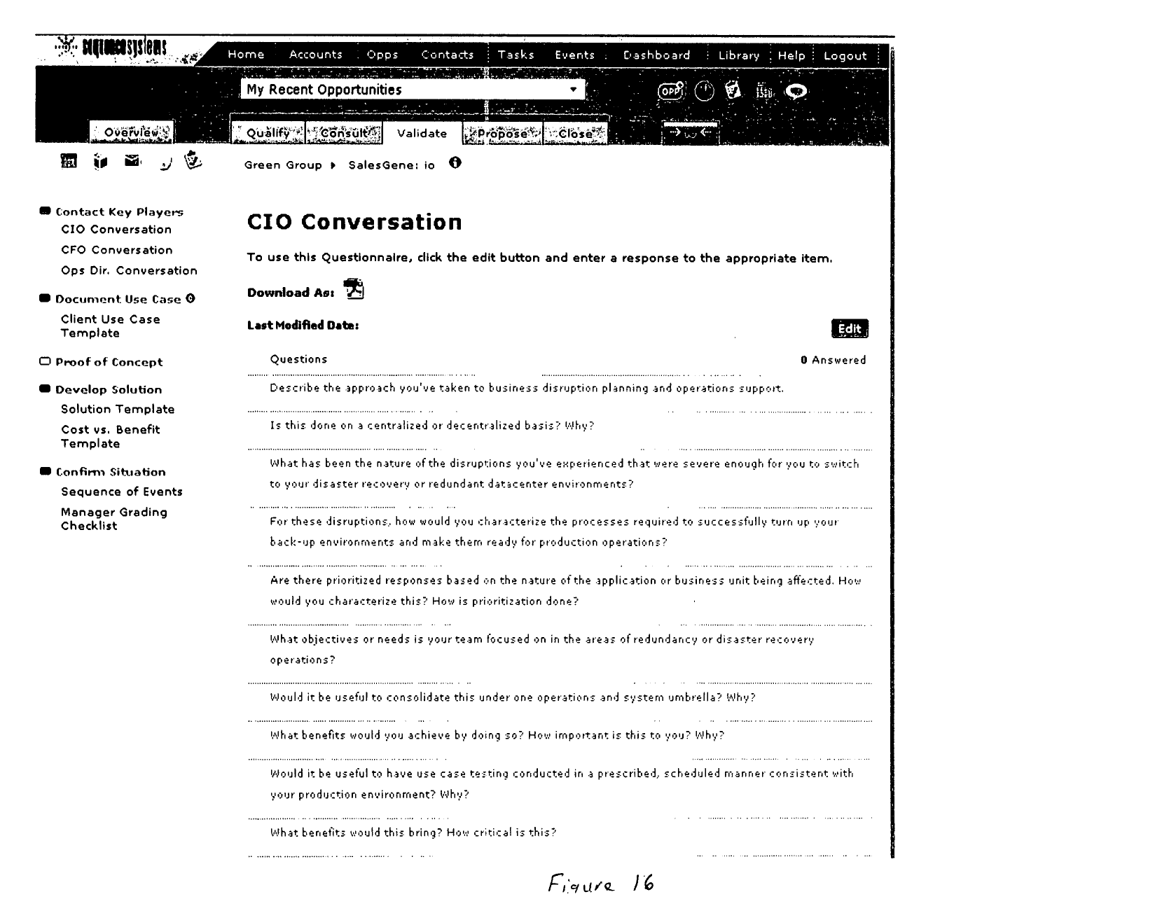

FIGS. 15-16 depict portions of the graphical user-interface used for implementing the Validate phase (or step) of the sales cycle. This step is used to develop management support and establish barriers to entry for the sales opportunity. Overview tab 1502 identifies the Activities in the Validate phase, including Contact Key Players (which includes the following Sub-Activities: CIO Questionnaire (which may developed or implemented using the screen shown in FIG. 16), CFO Questionnaire and Ops Director Questionnaire), Document Use Case, Proof of Concept, Develop Solution (which includes the following Sub-Activities: Solution Template and Cost vs. Benefit Template) and Confirm Situation (which includes the following Sub-Activities: Sequence of Events and manager Grading Checklist). Completion of each of these Activities is tracked by the software and used for generating the completion status information (204) shown in FIG. 2.

Referring to the Activities shown in tab 1502 for the Validate phase of the selling process, the links under the “Contact key Players” heading are used by the salesperson to gain agreement across all decision makers at the buyer organization on their primary objectives and their desire and ability to address them. The goal is to interview all of the key players involved in purchasing and deploying products of the selling organization. The screen shown in FIG. 16 corresponds to a CIO Conversion that is developed and accessed by the salesperson for the purpose of completing this Activity. Responses from the CIO to the questions shown can be recorded directly onto to the form shown in FIG. 16. Forms similar to the one shown in FIG. 16 are used for developing and accessing conversations with the CFO and Ops Director, and storing their responses in the system.

Referring still to the Activities shown in tab 1502 for the Validate phase of the selling process, the links under the “Document Use Case” heading are used by the salesperson to provide buyers with use case scenarios to instill confidence. Templates for the salesperson are made available under this activity to present to the buyer that asks for examples of uses for the sales offering. The links under the “Develop Solution” heading are used to develop a solution that specifically addresses the needs of the buyer based on their overall environment and project requirements. The links under this heading provide the salesperson with additional documents and support to weigh out benefits and costs associated with the sales opportunity. The links under the “Confirm Situation” heading are used to validate the salesperson's approach with the buyer and gain agreement with the buyer to a detailed sequence of events that would allow them to thoroughly evaluate the solution and make a decision to proceed.

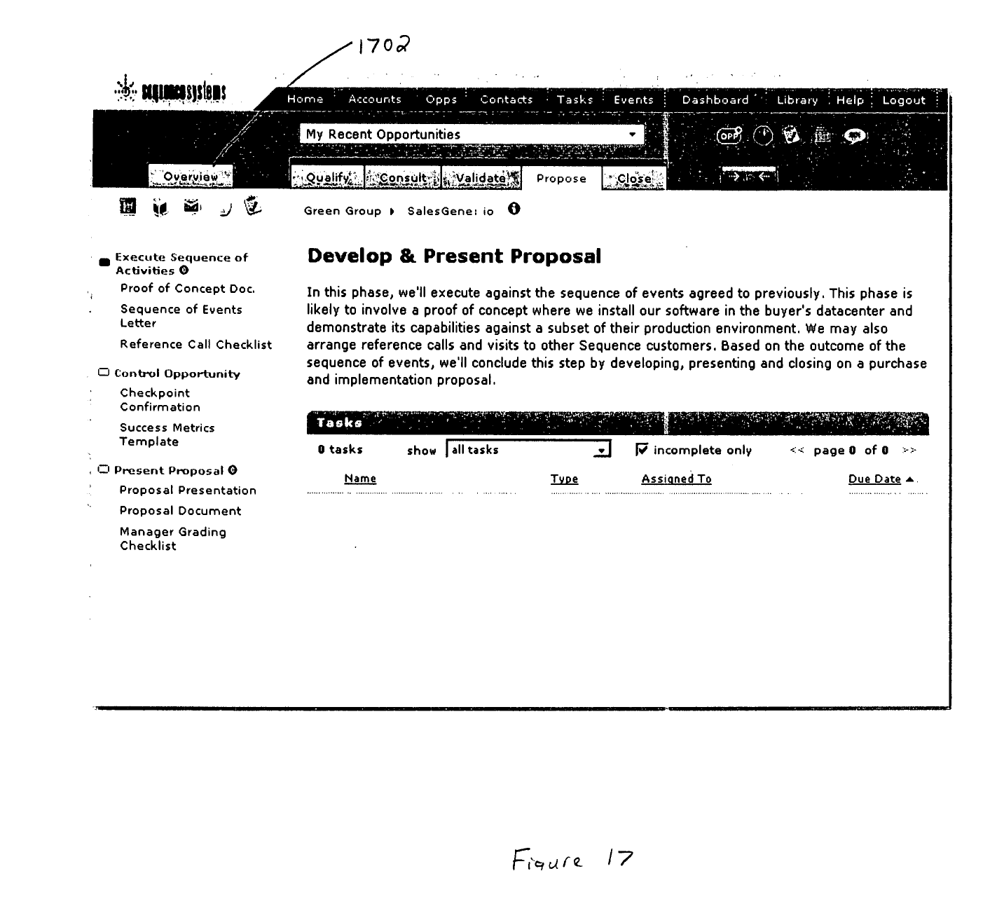

FIG. 17 depicts the portion of the graphical user-interface used for implementing the Propose phase (or step) of the sales cycle. Overview tab 1702 identifies the Activities in the Propose phase, including Execute Sequence of Activities (which includes the following Sub-Activities: Proof of Concept Document, Sequence of Events Letter and Reference Call Checklist), Control Opportunity (which includes the following Sub-Activities: Checkpoint Confirmation and Success Metrics Template) and Present Proposal (which includes the following Sub-Activities: Proposal Presentation, Proposal Document and manager Grading Checklist). Completion of each of these Activities is tracked by the software and used for generating the completion status information (204) shown in FIG. 2.

Referring to the Activities shown in tab 1702 for the Propose phase of the selling process, the links under the “Execute Sequence of Activities” provide a checklist of the detailed sequence of events agreed to with the buyer at the end of the Validate stage. Completion of each step in this sequence is tracked by the system. The links under this heading also include functionality to develop a proof of concept document, for demonstrating capabilities of the sales offering against a subset of the buyer's production environment.

Referring still to the Activities shown in tab 1702 for the Propose phase of the selling process, the links under the “Control Opportunity” heading provide checklists and templates for the proof of concept where the seller installs its software in the buyer's datacenter and demonstrates its capabilities against a subset of the buyer's production environment. The links under the “Present Proposal” include templates and checklists for developing, presenting and closing on a purchase and implementation proposal based on the outcome of the sequence of events agreed to with the buyer at the end of the Validate stage.

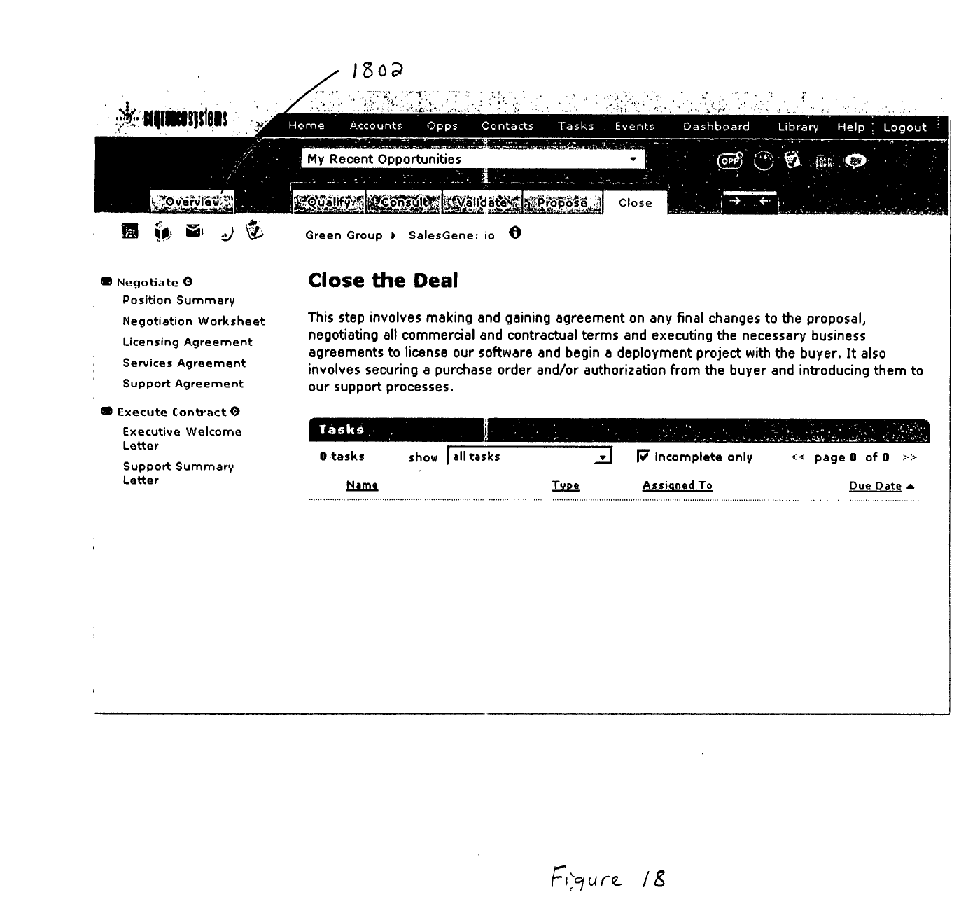

FIG. 18 depicts the portion of the graphical user-interface used for implementing the Close phase (or step) of the sales cycle. This step is used to negotiate commercial and project terms for the sales opportunity. Overview tab 1802 identifies the Activities in the Propose phase, including Negotiate (which includes the following Sub-Activities: Position Summary, Negotiation Worksheet, Licensing Agreement, Services Agreement and Support Agreement), and Execute Contract (which includes the following Sub-Activities: Executive Welcome Letter and Support Summary Letter). Completion of each of these Activities is tracked by the software and used for generating the completion status information (204) shown in FIG. 2.

Referring to the Activities shown in tab 1802 for the Close phase of the selling process, the links under the “Negotiate” heading provide templates and worksheets for negotiating contractual terms and executing the necessary business agreements to begin a deployment project with the buyer. The salesperson has the ability to use existing templates that can either be emailed or posted to the portal (discussed below) to share with the buyer. The links under the “Execute Contract” heading provide templates for securing a purchase order and/or authorization from the buyer and introducing them to the seller's support processes.

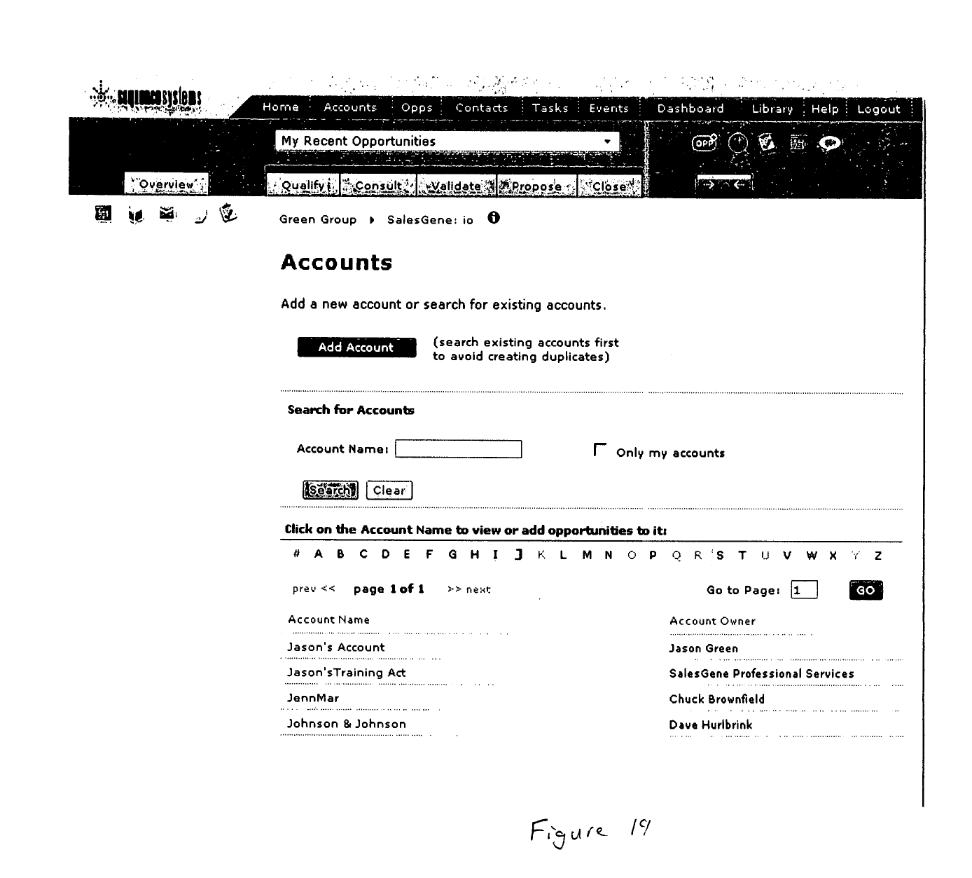

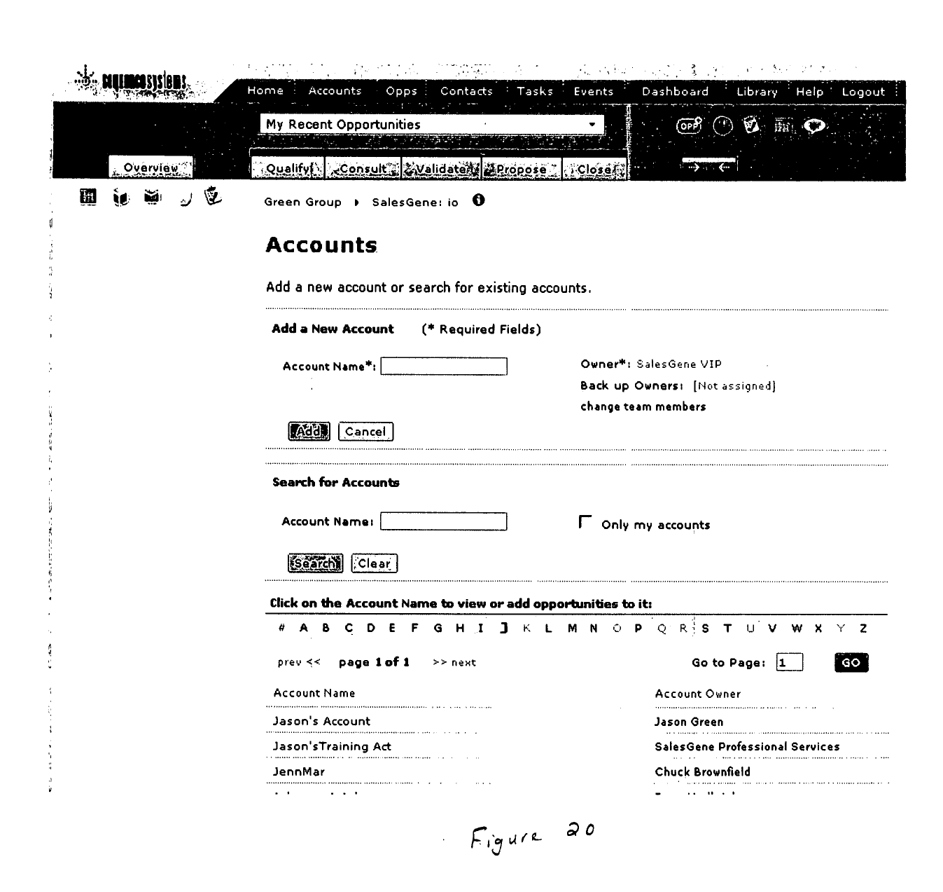

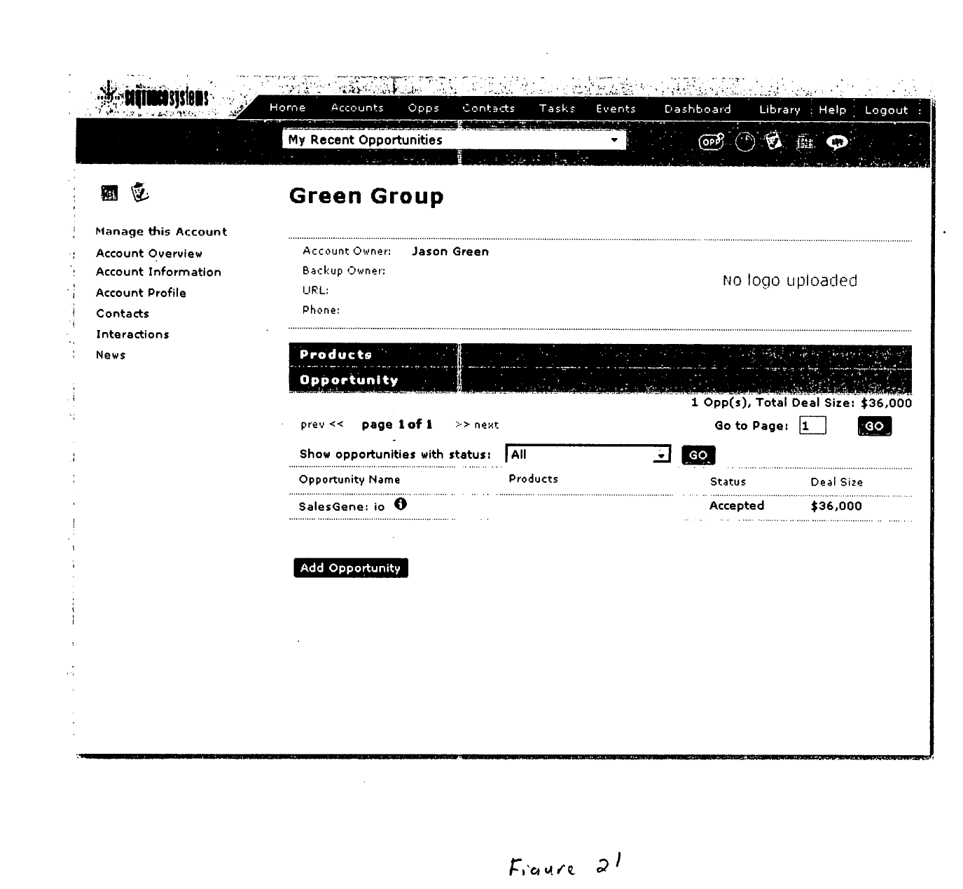

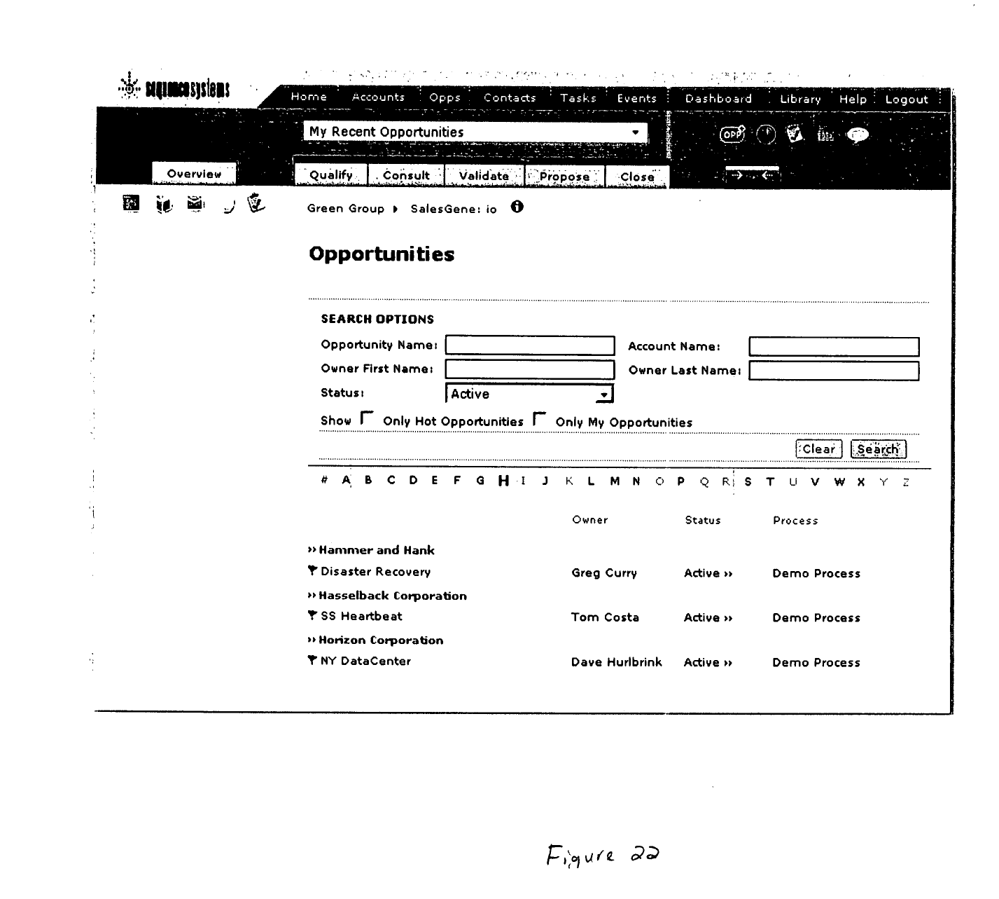

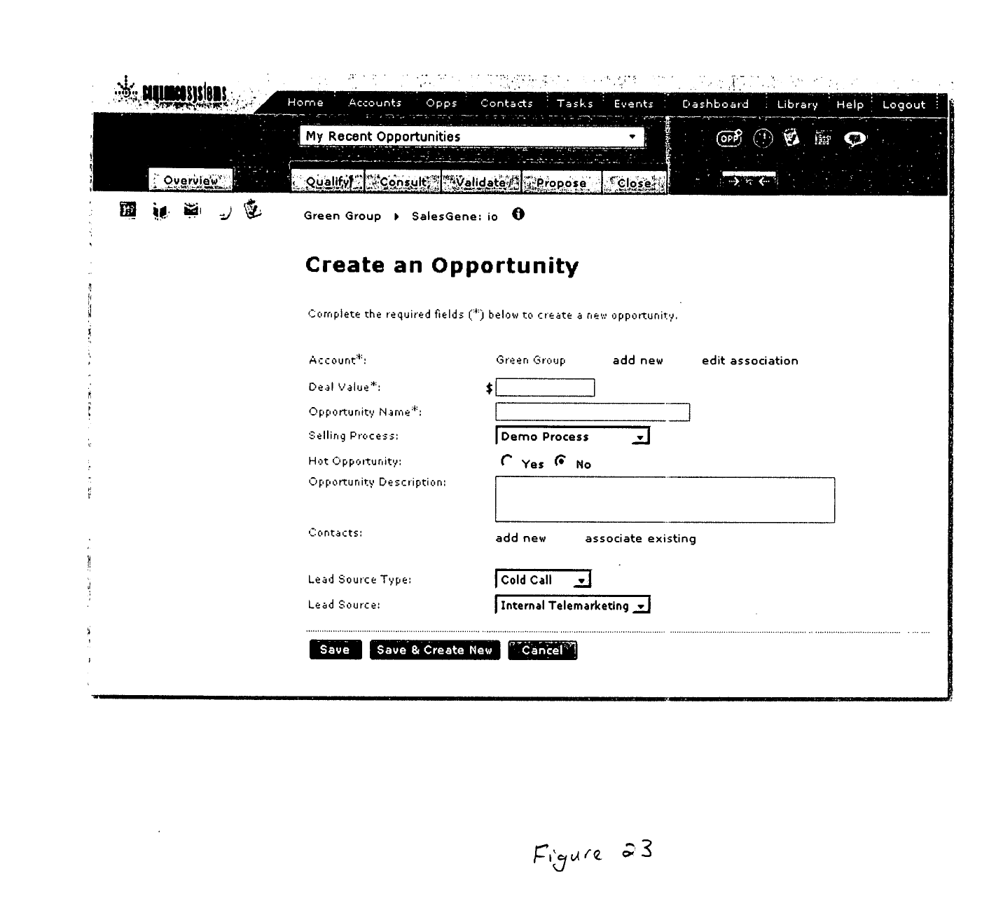

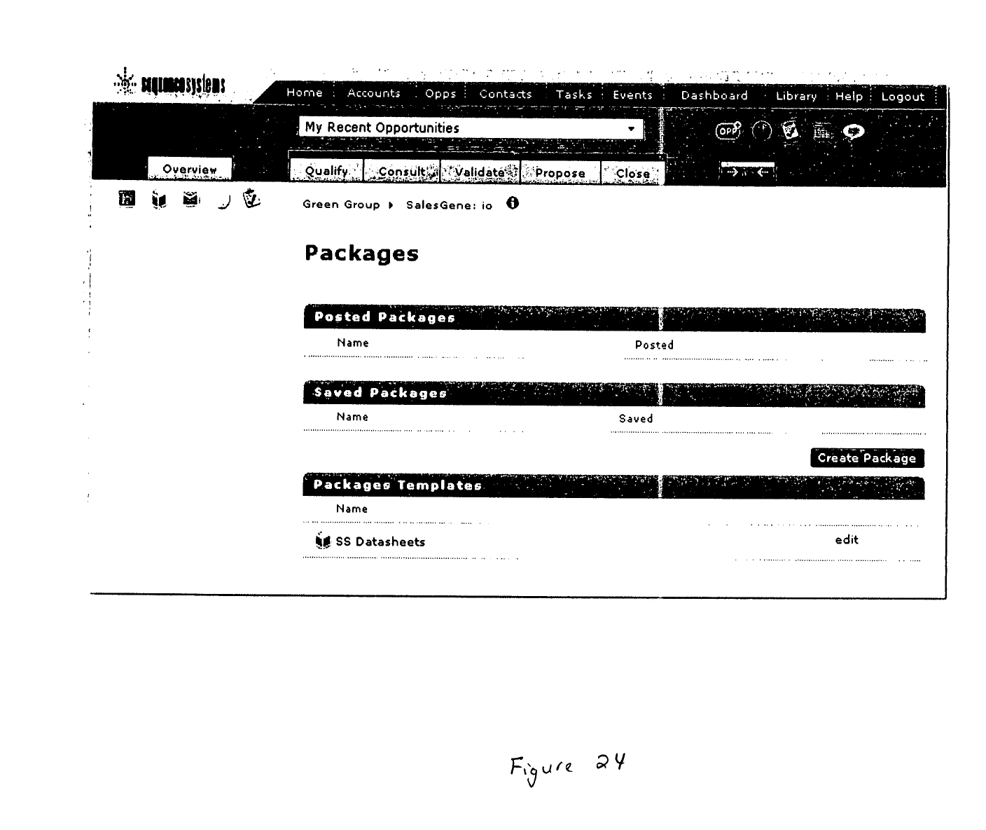

FIGS. 19-20 depict screens of the graphical-user interface used for creating, searching and editing customer account information. FIGS. 21-23 depict screens of the graphical-user interface used for creating, searching, viewing, marking and editing Opportunities. FIG. 24 depicts a screen of the graphical-user interface used for detailing files and documents collected in a repository type folder during the sales cycle for a particular opportunity, and packaged for a buyer to view and comment upon. The package can then be placed in the web portal (discussed below).

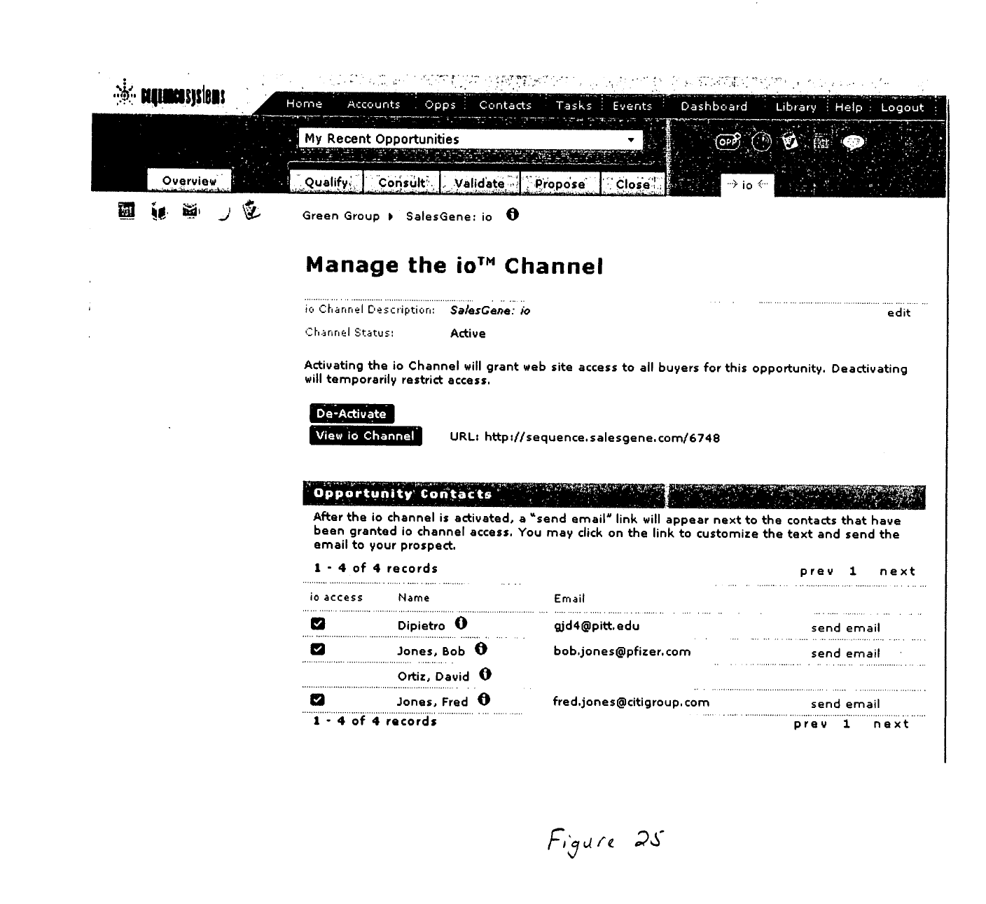

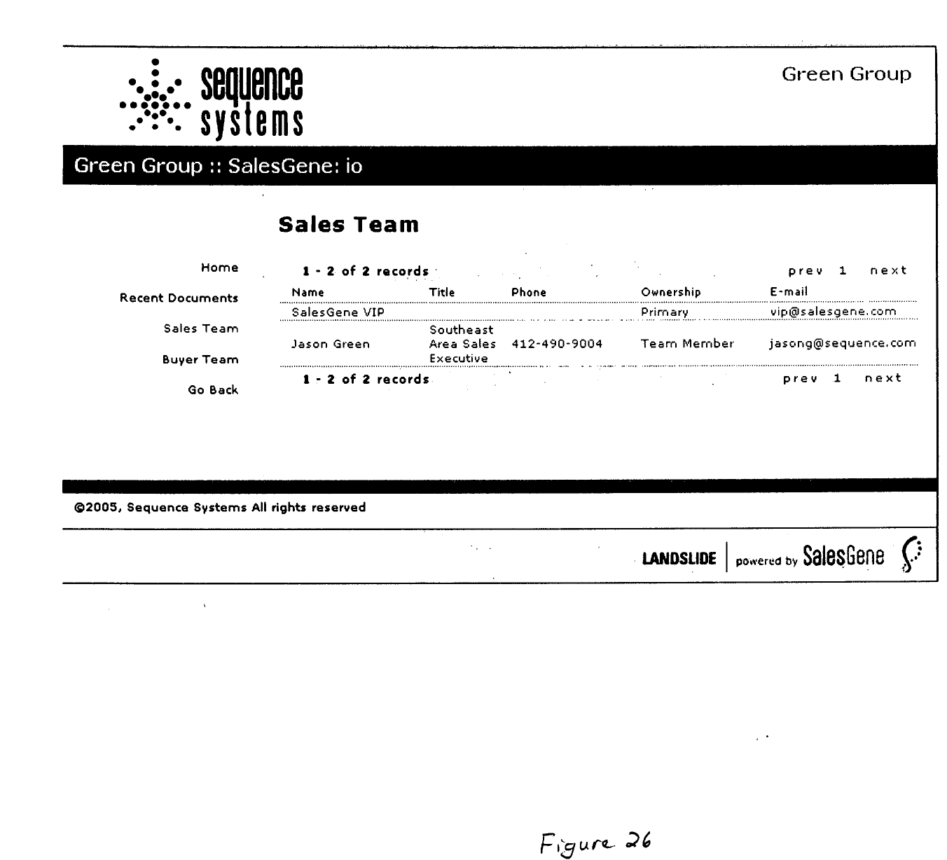

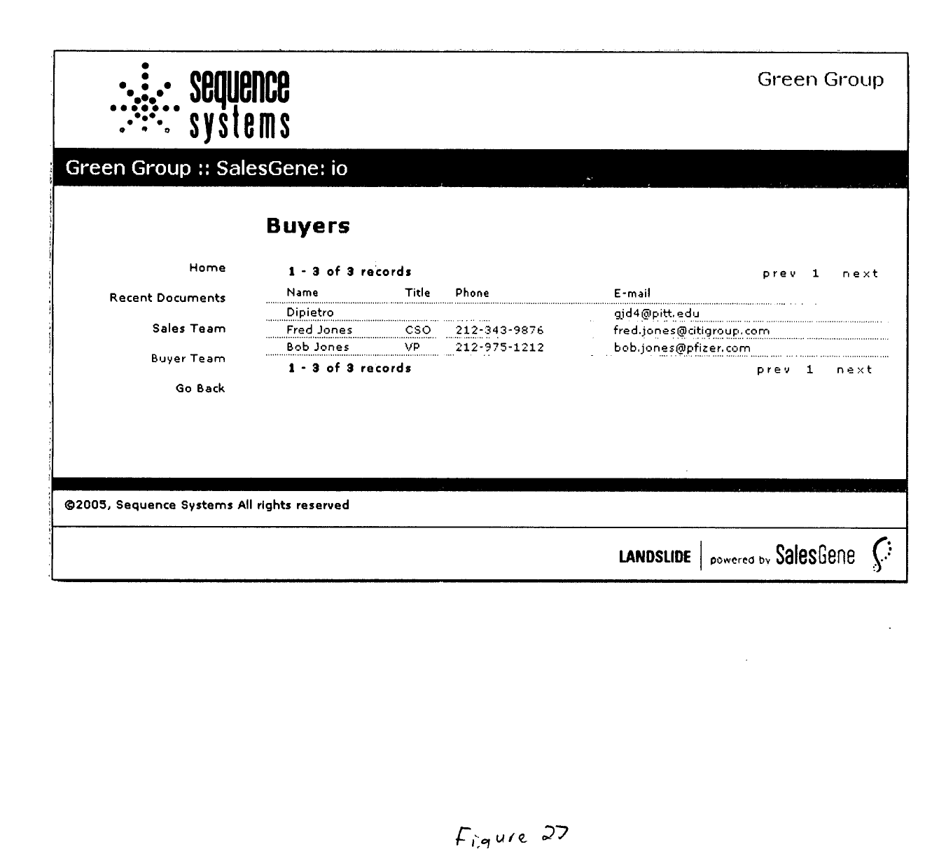

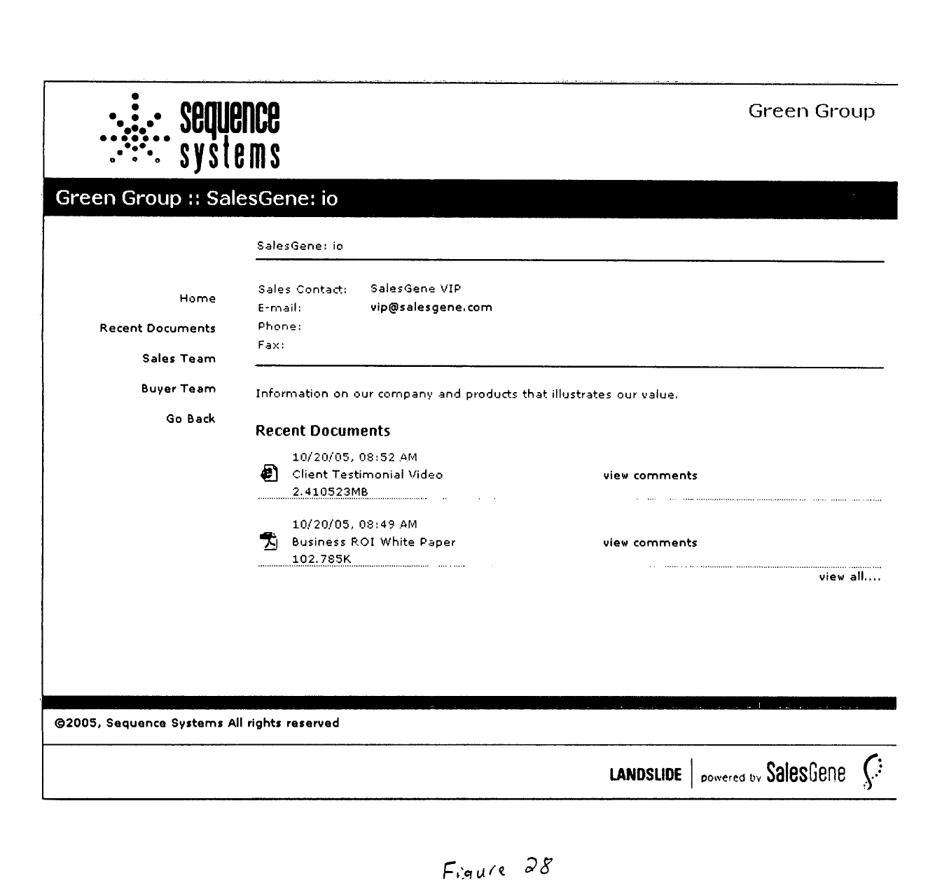

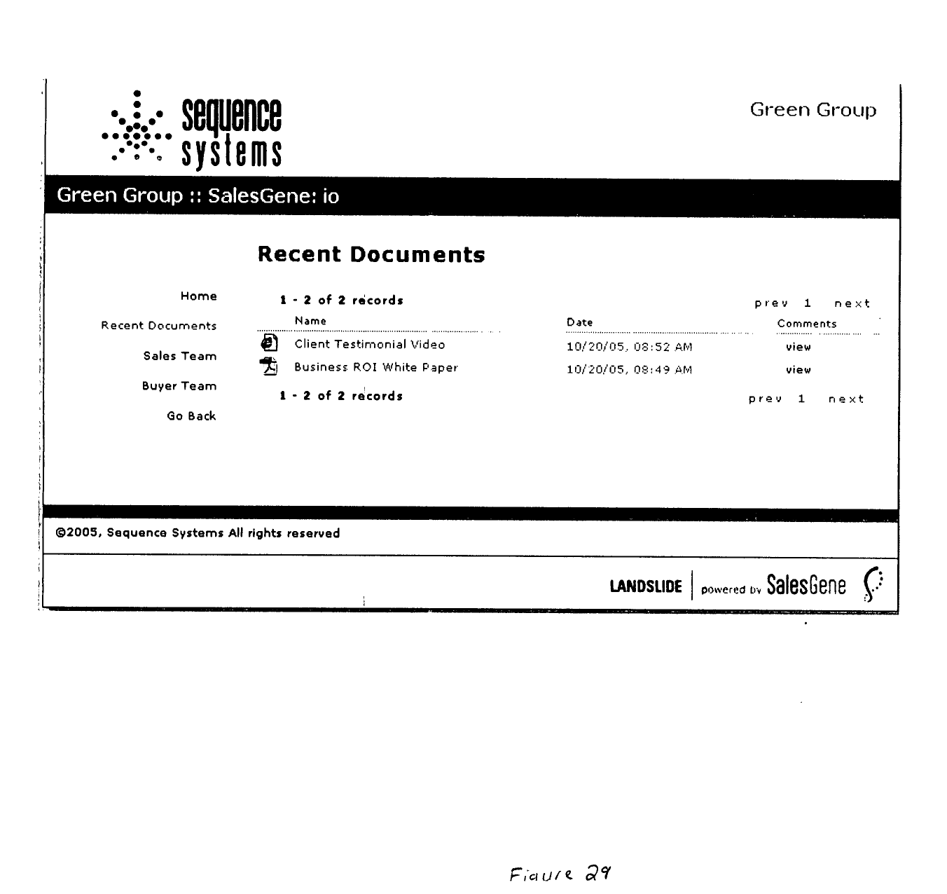

FIG. 25 depicts a screen of the graphical-user interface where a member of the selling organization can place information pertaining to a sales opportunity. The screen has a linked URL address which is given to the buyer to enter and view through their own web browser. This linked URL address corresponds to the web portal discussed below. FIGS. 26-29 depict screen shots of the web portal, where a member of the buyer organization can log in and view all the files and information placed by the seller organization. This site is password protected and is specific to the one opportunity and is the main basis of total control of the sales cycle.

Each document touched by a member of the buyer organization in the portal generates automatic background alerts to the seller. The alerts may be generated without knowledge of the buying organization. A member of the buyer organization can use the web portal to insert his own documents or information, ask questions, view his buying team, or view the sales team.

At least one viewing tool is provided, and made available to the members of the selling and prospective customer organizations who are involved in the prospective sales transaction, for viewing documents posted on the secure web site using the posting tool. The viewing tool displays posted documents stored in different formats to the members without requiring the members to access underlying programs used to generate the posted documents. The portal further includes at least one communication management tool that stores electronic communications between members of the selling and prospective customer organizations relating to the prospective sales transaction, and provides functionality for displaying past communications relating to the prospective sales transaction. At least one monitoring tool is provided, and made accessible only to members of the selling organization, for monitoring actions taken by members of the prospective customer organization using the secure web site.

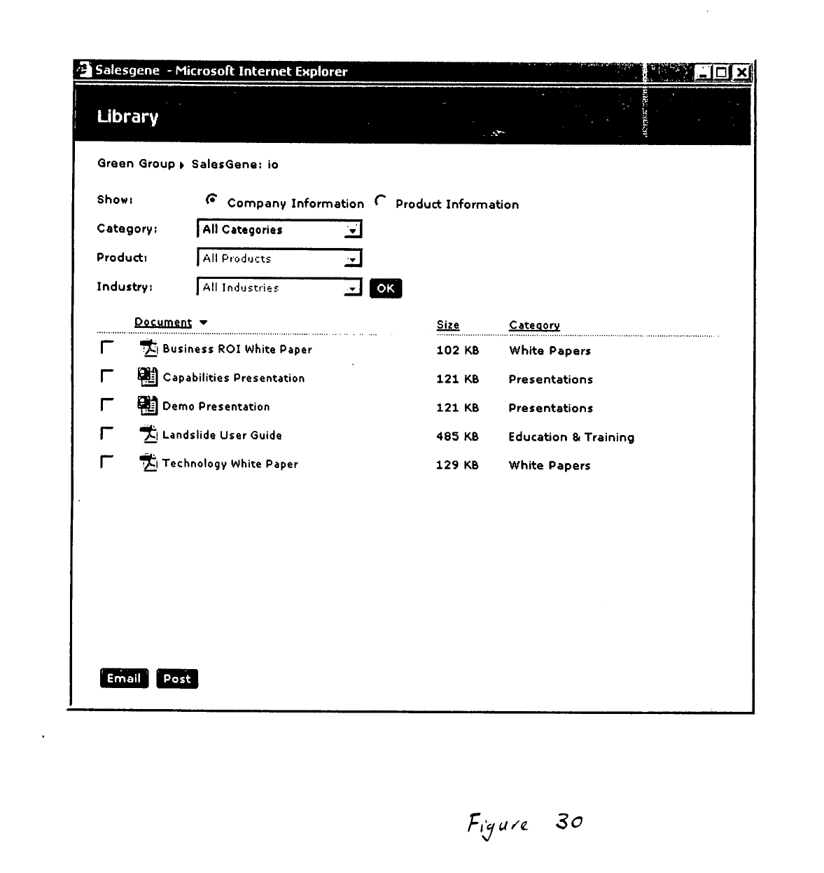

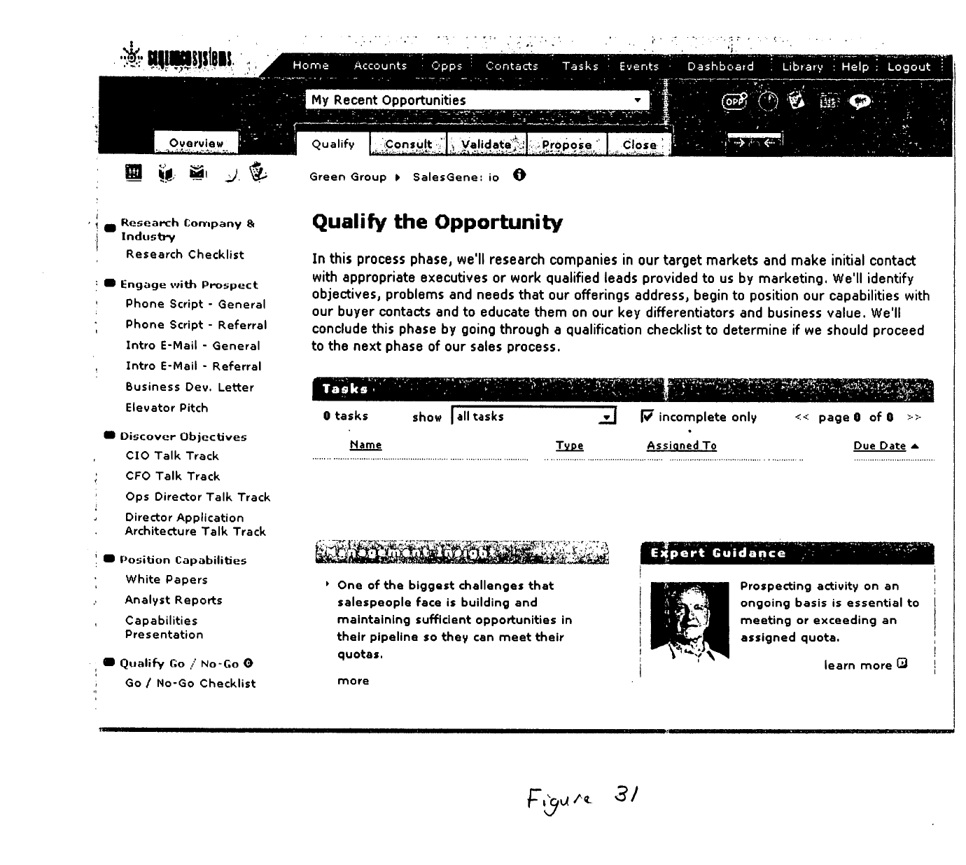

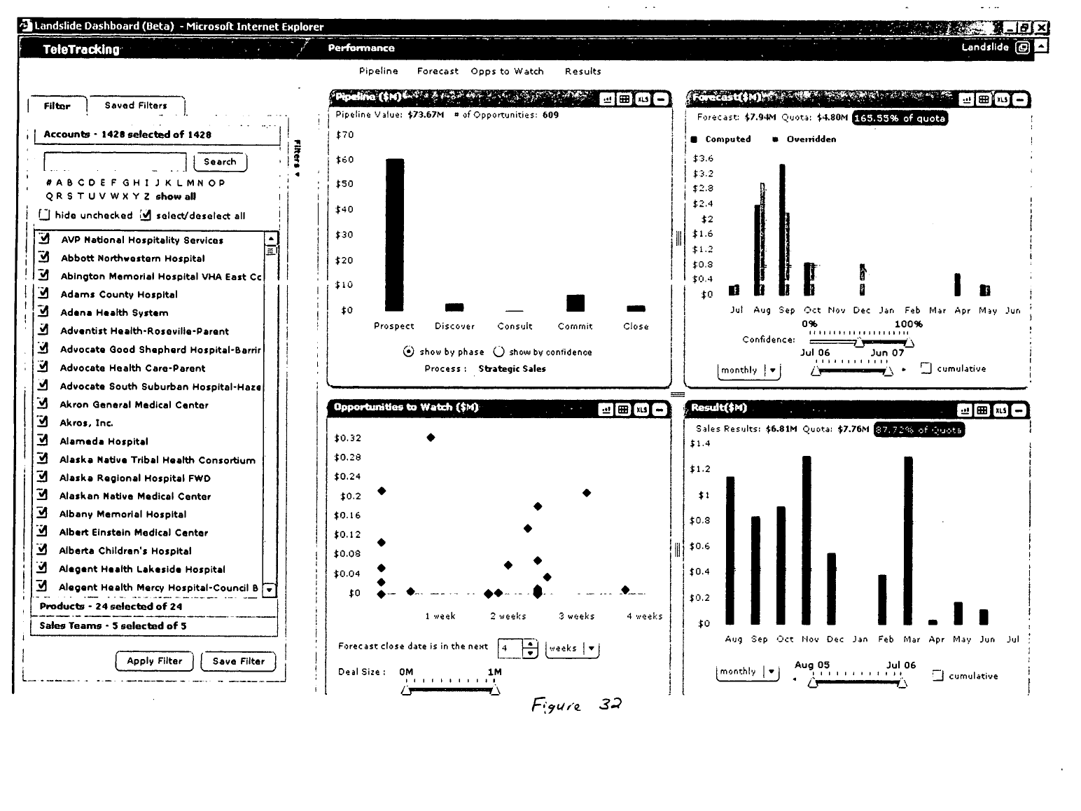

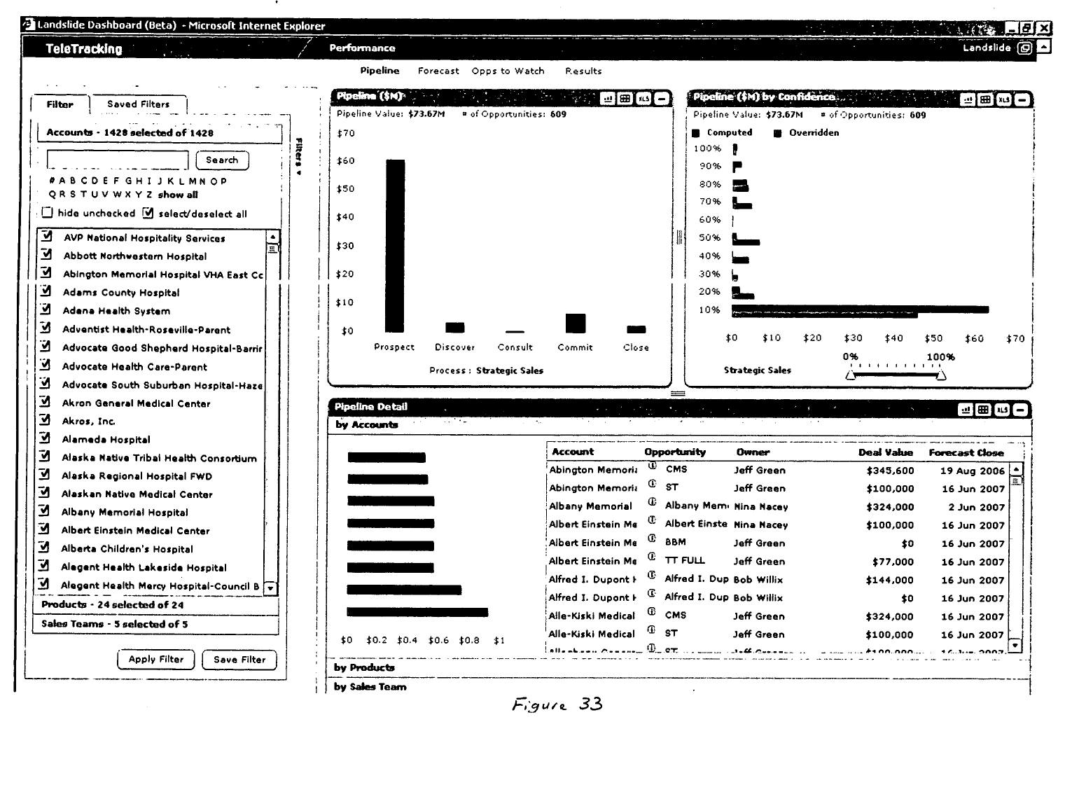

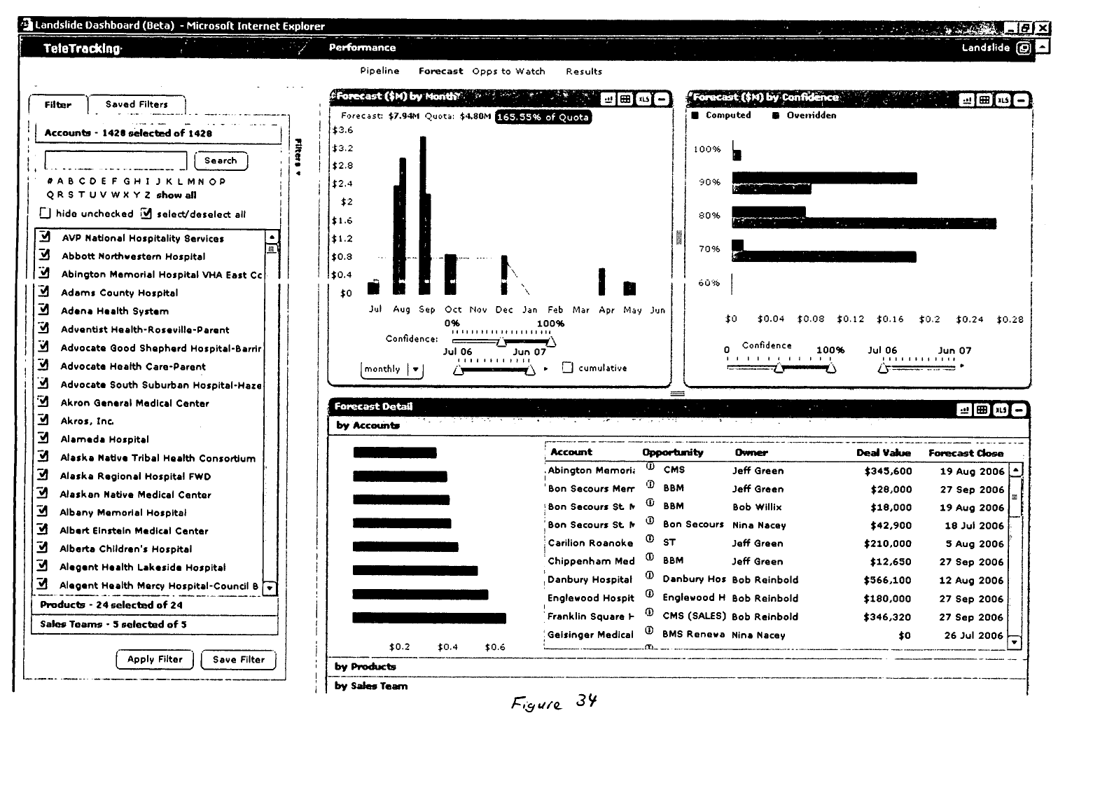

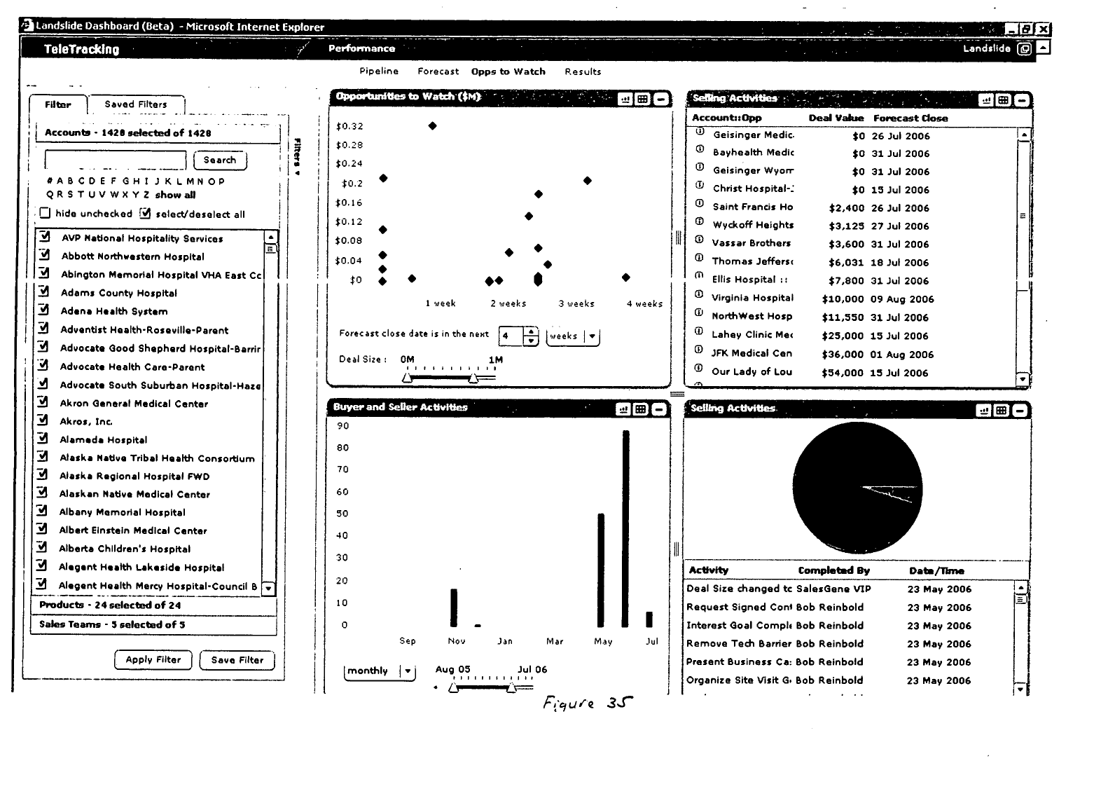

FIG. 30 depicts a screen of the graphical-user interface showing how the system collects in its library all documents and content created and customized throughout the sales cycle, tags them and makes them available in the sales process at the appropriate stage of the selling cycle. The library includes recommended suggestions and Best Practices documents. These documents can be marked explicitly by designated people in the sales organization or can be automatically designated as best practices based on criteria such as the frequency of the usage of the document and the relationship to successful sales wins. The library also includes a search capability based on criteria including content elements, the author, product, industry, selling phase and usage history.

FIG. 31 depicts a screen of the graphical-user interface where a member of the selling organization may obtain Expert Guidance (external guidance) and Management Insight (internal guidance). This information changes depending on the step of the sales cycle to best enable a sales person to act effectively.

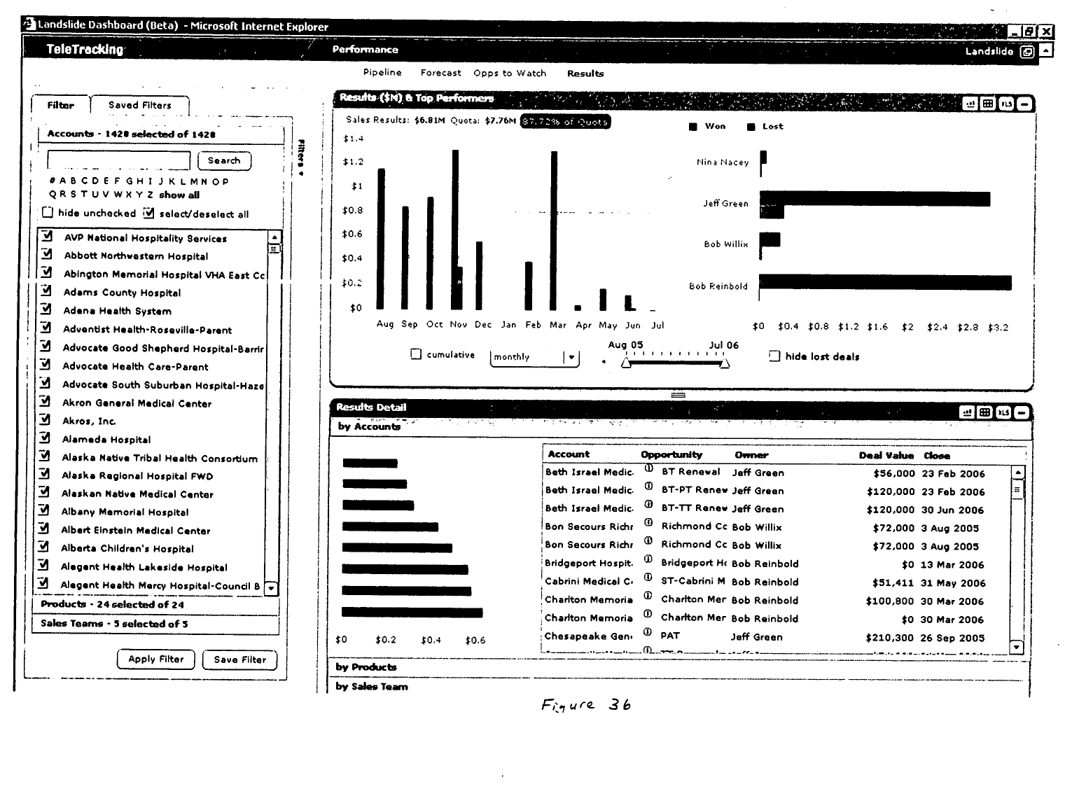

FIGS. 32-36 depict screens of the graphical-user interface showing forecasting reports generated by the graphical user interface. These screen depict a dashboard that provides Sales Reps, Sales Managers, and Senior Executive with a tool to assess the health of their Sales. The reports include a consolidated display of the completion status of a group of sales opportunities being pursued. The reports also include a computer generated Forecast of sales opportunities that will close and the likely time to close the sales opportunity based on historical data and weights assigned to tracked activities in the sales cycle, as well as subjective input from the salesperson with respect to pending opportunities. In one embodiment, the likely time to close for a given opportunity is automatically calculated by identifying the current phase of the opportunity, the current phase duration (i.e., how long the current phase has been in progress, the amount (if any) that the current phase has exceeded its expected duration, a comparison between the actual and expected dates of completion of the previous phase, and whether the current opportunity is ahead or behind schedule (as compared against benchmark values). The confidence level displayed for the Forecast (e.g., a percentage value that describes the likelihood that opportunities will be won) is automatically calculated using weights assigned by members of the sales team to each Activity associated with an Opportunity. The confidence level for a given Opportunity is defined as the sum of weight values for all Activities that have been completed in connection with the Opportunity.

The software tool of the present invention can be implemented on a general purpose computer, or a special purpose processor.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

What is claimed is:

1. An automated system that defines, implements and tracks the sales cycle applied by salespersons within an organization to sell goods or services offered by the organization to prospective customers, comprising:
a graphical user interface that displays a sales workflow that includes at least a plurality of pre-defined steps of the sales cycle, and automatically tracks completion status of each of the pre-defined steps with respect to each sales opportunity being pursued by a salesperson, wherein the system automatically tracks the completion status displayed by the graphical user-interface by tracking actions that the sales person has taken in furtherance of the sales opportunity using the graphical user-interface.

2. A system of automated tools that salespersons apply in a sales cycle within an organization to sell goods or services offered by the organization to prospective customers, comprising:
a graphical user interface that displays and implements a sales workflow that includes at least a plurality of pre-defined steps of the sales cycle; and
a plurality of software tools accessible by the sales person through the graphical user interface that displays and implements the sales workflow, wherein each of the tools is associated with one of the pre-defined steps of the sales cycle, and includes one or more templates for preparing a communication to a prospective customer being pursued by the sales person;
wherein each tool automatically identifies content needed to effectively execute selling activity based on the pre-defined step associated with the tool.

3. A computer-implemented web portal for automatically managing interactions relating to a prospective sales transaction between a selling organization and a prospective customer organization, comprising:
a secure web site accessible only to members of the selling and prospective customer organizations who are involved in the prospective sales transaction;
at least one posting tool, available to the members of the selling and prospective customer organizations who are involved in the prospective sales transaction, for posting communications relevant to the prospective sales transaction on the secure web site;
at least one viewing tool, available to the members of the selling and prospective customer organizations who are involved in the prospective sales transaction, for viewing documents posted on the secure web site using the posting tool; wherein the viewing tool displays posted documents stored in different formats to the members without requiring the members to access underlying programs used to generate the posted documents;
at least one communication management tool that stores electronic communications between members of the selling and prospective customer organizations relating to the prospective sales transaction; wherein the communication management tool provides functionality for displaying past communications relating to the prospective sales transaction; and
at least one monitoring tool, accessible only to members of the selling organization, for monitoring actions taken by members of the prospective customer organization using the secure web site.

4. An automated system that defines and implements the sales cycle applied by salespersons within an organization to sell goods or services offered by the organization to prospective customers, comprising:
a graphical user interface that displays a sales workflow that includes at least a plurality of pre-defined steps of the sales cycle; and
a software tool, accessible upon request by the sales person through the graphical user interface, that provides the sales person with expert internal and external guidance for completing one or more of the pre-defined steps of the sales cycle;
wherein the software tool automatically configures the expert guidance based on the pre-defined step of the sales cycle that the sales person is attempting to complete.

5. An automated system that defines, implements and tracks the sales cycle applied by salespersons within an organization to sell goods or services offered by the organization to prospective customers, comprising:
a graphical user interface that displays to each sales person a sales workflow that includes at least a plurality of pre-defined steps of the sales cycle, and a completion status of each of the pre-defined steps with respect to each sales opportunity being pursued by the salesperson;
wherein the graphical user interface also displays to a manager of each sales person a consolidated display of the completion status of a group of sales opportunities being pursued by such sales person; and
wherein the system automatically computes the probability or confidence level of a sales opportunity and the likely time to close the sales opportunity based on historical data and weights assigned to activities in the sales cycle.

6. An automated system that defines and implements the sales cycle applied by salespersons within an organization to sell goods or services offered by the organization to a prospective customer organization, comprising:
a graphical user interface that displays a sales workflow that includes at least a plurality of pre-defined steps of the sales cycle; and
a software tool that automatically provides one or more alerts relevant to the prospective sales opportunity to the sales person through the graphical user interface when a member of the prospective customer organization accesses a document previously made available by the sales person.

7. An automated system that defines, implements and tracks the sales cycle applied by salespersons within an organization to sell goods or services offered by the organization to prospective customers, comprising:
a graphical user interface that displays to each sales person a sales workflow that includes at least a plurality of pre-defined steps of the sales cycle, and a completion status of each of the pre-defined steps with respect to each sales opportunity being pursued by the salesperson;
wherein the system collects in a library documents and content created and customized throughout the sales cycle, tags the documents and content stored in the library, and makes the documents and content from the library available to the salesperson at the appropriate stage of the selling cycle;
wherein the library includes documents that recommend suggestions and best practices for completing activities in the sales cycle; and
wherein the system automatically designates a document stored in a library as a best practice based on the frequency of the usage of the document and the relationship of the document to successful sales.
